(19) United States
(12) Patent Application Publication
(10) Pub. No.: US 2023/0100586 A1
(43) Pub. Date: Mar. 30, 2023

(54) CIRCUITRY AND METHODS FOR ACCELERATING STREAMING DATA-TRANSFORMATION OPERATIONS

(71) Applicant: Intel Corporation, Santa Clara, CA (US)

(72) Inventors: Utkarsh Y. Kakaiya, Folsom, CA (US); Vinodh Gopal, Westborough, MA (US)

(21) Appl. No.: 17/484,840

(22) Filed: Sep. 24, 2021

(51) Int. Cl. G06F 9/48; G06F 9/30

(52) U.S. Cl. CPC G06F 9/4881; G06F 9/30145

(57) ABSTRACT

Systems, methods, and apparatuses for accelerating streaming data-transformation operations are described. In one example, a system on a chip (SoC) includes a hardware processor core comprising a decoder circuit to decode an instruction comprising an opcode into a decoded instruction, the opcode to indicate an execution circuit is to generate a single descriptor and cause the single descriptor to be sent to an accelerator circuit coupled to the hardware processor core, and the execution circuit to execute the decoded instruction according to the opcode; and the accelerator circuit comprising a work dispatcher circuit and one or more work execution circuits to, in response to the single descriptor sent from the hardware processor core: when a field of the single descriptor is a first value, cause a single job to be sent by the work dispatcher circuit to a single work execution circuit of the one or more work execution circuits to perform an operation indicated in the single descriptor to generate an output, and when the field of the single descriptor is a second different value, cause a plurality of jobs to be sent by the work dispatcher circuit to the one or more work execution circuits to perform the operation indicated in the single descriptor to generate the output as a single stream.

### TECHNICAL FIELD

The disclosure relates generally to electronics, and, more specifically, an example of the disclosure relates to circuitry for accelerating streaming data-transformation operations.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a block diagram of a computer system including a plurality of cores, a memory, and an accelerator including a work dispatcher circuit according to examples of the disclosure.

FIG. 2 illustrates a block diagram of a hardware processor including a plurality of cores according to examples of the disclosure.

FIG. 3 is a block flow diagram of a decryption/decompression circuit according to examples of the disclosure.

FIG. 4 is a block flow diagram of a compressor/encryption circuit according to examples of the disclosure.

FIG. 5 is a block diagram of a first computer system coupled to a second computer system via one or more networks according to examples of the disclosure.

FIG. 6 illustrates a block diagram of a hardware processor having a plurality of cores and a hardware accelerator coupled to a data storage device according to examples of the disclosure.

FIG. 6 illustrates a block diagram of a hardware processor having a plurality of cores and a hardware accelerator coupled to a data storage device according to examples of the disclosure.

FIG. 7 illustrates a block diagram of a hardware processor having a plurality of cores coupled to a data storage device and to a hardware accelerator coupled to the data storage device according to examples of the disclosure.

FIG. 8 illustrates a hardware processor coupled to storage that includes one or more job enqueue instructions according to examples of the disclosure.

FIG. 9A illustrates a block diagram of a computer system including a processor core sending a plurality of jobs to an accelerator according to examples of the disclosure.

FIG. 9B illustrates a block diagram of a computer system including a processor core sending a single (e.g., streaming) descriptor for a plurality of jobs to an accelerator according to examples of the disclosure.

FIG. 10 is a block flow diagram of a compression operation on a plurality of contiguous memory pages according to examples of the disclosure.

FIG. 11 illustrates an example format of a descriptor according to examples of the disclosure.

FIG. 12A illustrates an example “number of bytes” format of a transfer size field of a descriptor according to examples of the disclosure.

FIG. 12B illustrates an example “chunk” format of a transfer size field of a descriptor according to examples of the disclosure.

FIG. 13 is a block flow diagram of a compression operation on a plurality of non-contiguous memory pages according to examples of the disclosure.

FIG. 14 illustrates an example address type format of a source and/or destination address field of a descriptor according to examples of the disclosure.

FIG. 15A illustrates a block diagram of a scalable accelerator including a work acceptance unit, a work dispatcher, and a plurality of work execution engines according to examples of the disclosure.

FIG. 15B illustrates a block diagram of the scalable accelerator having a serial disperser according to examples of the disclosure.

FIG. 15C illustrates a block diagram of the scalable accelerator having a parallel disperser according to examples of the disclosure.

FIG. 15D illustrates a block diagram of the scalable accelerator having the parallel disperser and an accumulator according to examples of the disclosure.

FIG. 16 is a block flow diagram of a compression operation on a plurality of memory pages that generates metadata for each compressed page according to examples of the disclosure.

FIG. 17A illustrates an example format of an output stream of an accelerator that includes metadata according to examples of the disclosure.

FIG. 17B illustrates an example format of an output stream of an accelerator that includes metadata and an additional “padding” value according to examples of the disclosure.

FIG. 17C illustrates an example format of an output stream of an accelerator that includes metadata, an additional “padding” value, and an additional (e.g., pre-selected) “placeholder” value according to examples of the disclosure.

FIG. 18 is a flow diagram illustrating operations of a method of acceleration according to examples of the disclosure.

FIG. 19A is a block diagram illustrating a generic vector friendly instruction format and class A instruction templates thereof according to examples of the disclosure.

FIG. 19B is a block diagram illustrating the generic vector friendly instruction format and class B instruction templates thereof according to examples of the disclosure.

FIG. 20A is a block diagram illustrating fields for the generic vector friendly instruction formats in FIGS. 19A and 19B according to examples of the disclosure.

FIG. 20B is a block diagram illustrating the fields of the specific vector friendly instruction format in FIG. 20A that make up a full opcode field according to one example of the disclosure.

FIG. 20C is a block diagram illustrating the fields of the specific vector friendly instruction format in FIG. 20A that make up a register index field according to one example of the disclosure.

FIG. 20D is a block diagram illustrating the fields of the specific vector friendly instruction format in FIG. 20A that make up the augmentation operation field 1950 according to one example of the disclosure.

FIG. 21 is a block diagram of a register architecture according to one example of the disclosure

FIG. 22A is a block diagram illustrating both an exemplary in-order pipeline and an exemplary register renaming, out-of-order issue/execution pipeline according to examples of the disclosure.

FIG. 22B is a block diagram illustrating both an exemplary example of an in-order architecture core and an exemplary register renaming, out-of-order issue/execution architecture core to be included in a processor according to examples of the disclosure.

FIG. 23A is a block diagram of a single processor core, along with its connection to the on-die interconnect network and with its local subset of the Level 2 (L2) cache, according to examples of the disclosure.

FIG. 23B is an expanded view of part of the processor core in FIG. 23A according to examples of the disclosure.

FIG. 24 is a block diagram of a processor that may have more than one core, may have an integrated memory controller, and may have integrated graphics according to examples of the disclosure.

FIG. 25 is a block diagram of a system in accordance with one example of the present disclosure.

FIG. 26 is a block diagram of a more specific exemplary system in accordance with an example of the present disclosure.

FIG. 27, shown is a block diagram of a second more specific exemplary system in accordance with an example of the present disclosure.

FIG. 28, shown is a block diagram of a system on a chip (SoC) in accordance with an example of the present disclosure.

FIG. 29 is a block diagram contrasting the use of a software instruction converter to convert binary instructions in a source instruction set to binary instructions in a target instruction set according to examples of the disclosure.

### DETAILED DESCRIPTION

In the following description, numerous specific details are set forth. However, it is understood that examples of the disclosure may be practiced without these specific details. In other instances, well-known circuits, structures, and techniques have not been shown in detail in order not to obscure the understanding of this description.

References in the specification to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. Certain operations include accessing one or more memory locations, e.g., to store and/or read (e.g., load) data. A system may include a plurality of cores, e.g., with a proper subset of cores in each socket of a plurality of sockets, e.g., of a system-on-a-chip (SoC). Each core (e.g., each processor or each socket) may access data storage (e.g., a memory). Memory may include volatile memory (e.g., dynamic random-access memory (DRAM)) or (e.g., byte-addressable) persistent (e.g., non-volatile) memory (e.g., non-volatile RAM) (e.g., separate from any system storage, such as, but not limited, separate from a hard disk drive). One example of persistent memory is a dual in-line memory module (DIMM) (e.g., a non-volatile DIMM) (e.g., an Intel® Optane™ memory), for example, accessible according to a Peripheral Component Interconnect Express (PCIe) standard.

Certain examples utilize a “far memory” in a memory hierarchy, e.g., to store infrequently accessed (e.g., “cold”) data into the far memory. Doing so allows certain system to perform a same operation(s) with a lower volatile memory (e.g., DRAM) capacity. Persistent memory may be used as a second tier of memory (e.g., “far memory”), e.g., with volatile memory (e.g., DRAM) being a first tier of memory (e.g., “near memory”).

In one example, a processor is coupled to an (e.g., on die or off die) accelerator (e.g., an offload engine) to perform one or more (e.g., offloaded) operations, for example, instead of those operations being performed only on the processor. In one example, a processor includes an (e.g., on die or off die) accelerator (e.g., an offload engine) to perform one or more operations, for example, instead of those operations being performed only on the processor.

In certain examples, an accelerator is to perform data-transformation operations, e.g., instead of utilizing the execution resources of a hardware processor core. Two non-limiting examples of data-transformation operations are a compression operation and a decompression operation. A compression operation may refer to encoding information using fewer bits than the original representation. A decompression operation may refer to decoding the compressed information back into the original representation. A compression operation may compress data from a first format to a compressed, second format. A decompression operation may decompress data from a compressed, first format to an uncompressed, second format. A compression operation may be performed according to an (e.g., compression) algorithm. A decompression operation may be performed according to an (e.g., decompression) algorithm.

In one example, an accelerator performs a compression operation and/or decompression operation in response to a request to and/or for a processor (e.g., a central processing unit (CPU)) to perform that operation. An accelerator may be a hardware compression accelerator or a hardware decompression accelerator. An accelerator may couple to memory (e.g., on die with an accelerator or off die) to read and/or store data, e.g., the input data and/or the output data. An accelerator may utilize one or more buffers (e.g., on die with an accelerator or off die) to read and/or store data, e.g., the input data and/or the output data. In one example, an accelerator couples to an input buffer to load input therefrom. In one example, an accelerator couples to an output buffer to store output thereon. A processor may execute an instruction to offload an operation or operations (e.g., for an instruction, a thread of instructions, or other work) to an accelerator.

An operation may be performed on a data stream (e.g., stream of input data). A data stream may be an encoded, compressed data stream. In one example, data is first compressed, e.g., according to a compression algorithm, such as, but not limited to, the LZ77 lossless data compression algorithm or the LZ78 lossless data compression algorithm. In one example, a compressed symbol that is output from a compression algorithm is encoded into a code, for example, encoded according to the Huffman algorithm (Huffman encoding), e.g., such that more common symbols are represented by code that uses fewer bits than less common symbols. In certain examples, a code that represents (e.g., maps to) a symbol includes fewer bit in the code than in the symbol. In certain examples of encoding, each fixed-length input symbol is represented by (e.g., maps to) a corresponding variable-length (e.g., prefix free) output code (e.g., code value).

The DEFLATE data compression algorithm may be utilized to compress and decompress a data stream (e.g., data set). In certain examples of a DEFLATE compression, a data stream (e.g., data set) is divided into a sequence of data blocks and each data block is compressed separately. An end-of-block (EOB) symbol may be used to denote the end of each block. In certain examples of a DEFLATE compression, the LZ77 algorithm contributes to DEFLATE compression by allowing repeated character patterns to be represented with (length, distance) symbol pairs where a length symbol represents the length of a repeating character pattern and a distance symbol represents its distance, e.g., in bytes, to an earlier occurrence of the pattern. In certain examples of a DEFLATE compression, if a character pattern is not represented as a repetition of its earlier occurrence, it is represented by a sequence of literal symbols, e.g., corresponding to 8-bit byte patterns.

In certain examples, Huffman encoding is used in DEFLATE compression for encoding the length, distance, and literal symbols, e.g., and end-of-block symbols. In one example, the literal symbols (e.g., values from 0 to 255), for example, used for representing all 8-bit byte patterns, together with the end-of-block symbol (e.g., the value 256) and the length symbols (e.g., values 257 to 285), are encoded as literal/length codes using a first Huffman code tree. In one example, the distance symbols (e.g., represented by the values from 0 to 29) are encoded as distance codes using a separate, second Huffman code tree. Code trees may be stored in a header of the data stream. In one example, every length symbol has two associated values, a base length value and an additional value denoting the number of extra bits to be read from the input bit-stream. The extra bits may be read as an integer which may be added to the base length value to give the absolute length represented by the length symbol occurrence. In one example, every distance symbol has two associated values, a base distance value and an additional value denoting the number of extra bits to be read from the input bit-stream. The base distance value may be added to the integer made up of the associated number of extra bits from the input bit-stream to give the absolute distance represented by the distance symbol occurrence. In one example, a compressed block of DEFLATE data is a hybrid of encoded literals and LZ77 look-back indicators terminated by an end-of-block indicator. In one example, DEFLATE may be used to compress a data stream and INFLATE may be used to decompress the data stream. INFLATE may generally refer to the decoding process that takes a DEFLATE data stream for decompression (and decoding) and correctly produces the original full-sized data or file. In one example, a data stream is an encoded, compressed DEFLATE data stream, for example, including a plurality of literal codes (e.g., codewords), length codes (e.g., codewords), and distance codes (e.g., codewords).

In certain examples, when a processor (e.g., CPU) sends work to a hardware accelerator (e.g., device), the processor (e.g., CPU) creates a description of the work to be completed (e.g., a descriptor) and submits the description (e.g., descriptor) to the hardware implemented accelerator. In certain examples, the descriptor is sent by a (e.g., special) instructions (e.g., job enqueue instructions) or via memory mapped input/output (MMIO) write transactions, for example, where a processor page-table maps device (e.g., accelerator) visible virtual addresses (e.g., device addresses or I/O addresses) to corresponding physical addresses in memory. In certain examples, a page of memory (e.g., a memory page or virtual page) is a fixed-length contiguous block of virtual memory described by a single entry in a page table (e.g., in DRAM) that stores the mappings between virtual addresses and physical addresses (e.g., with the page being the smallest unit of data for memory management in a virtual memory operating system). A memory subsystem may include a translation lookaside buffer (e.g., TLB) (e.g., in a processor) to convert a virtual address to a physical address (e.g., of a system memory). A TLB may include a data table to store (e.g., recently used) virtual-to-physical memory address translations, e.g., such that the translation does not have to be performed on each virtual address present to obtain the physical memory address. If the virtual address entry is not in the TLB, a processor may perform a page walk in a page table to determine the virtual-to-physical memory address translation.

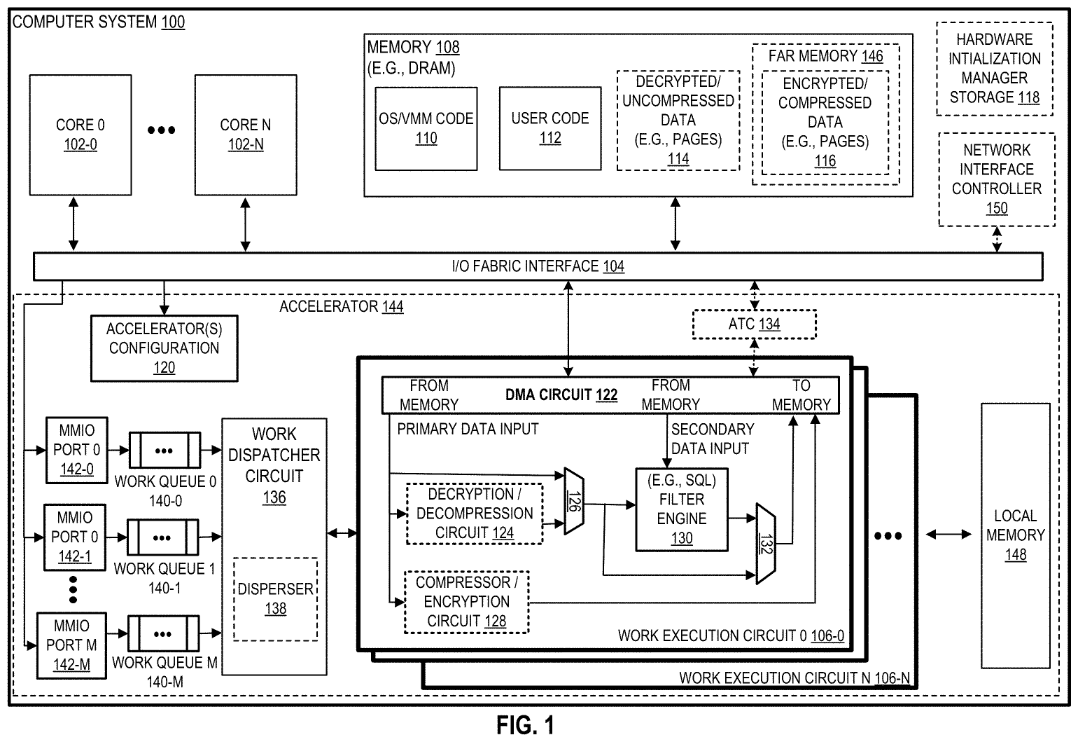

One or more types of accelerators may be utilized. For example, a first type of accelerator may be accelerator 144 from FIG. 1, e.g., an In-Memory Analytics accelerator (IAX). A second type of accelerator supports a set of transformation operations on memory, e.g., a data streaming accelerator (DSA). For example, to generate and test cyclic redundancy check (CRC) checksum or Data Integrity Field (DIF) to support storage and networking applications and/or for memory compare and delta generate/merge to support VM migration, VM Fast check-pointing, and software managed memory deduplication usages. A third type of accelerator supports security, authentication, and compression operations (e.g., cryptographic acceleration and compression operations), e.g., a QuickAssist Technology (QAT) accelerator.

In certain examples, an accelerator performs data-transformation operations. For certain data-transformation operations, the size of the input and the output is different, and the output size may be dependent on the contents of one or more input buffers, e.g., for a compression operation. In certain examples, software submits a job to (e.g., cause an accelerator to) compress an input buffer of a certain size (e.g., 4K bytes or 4096 bytes) but provides a (e.g., single) output buffer large enough to hold the compressed data (e.g., 4K bytes or 4096 bytes). Depending upon the contents, the accelerator may compress the data down, e.g., to 1K, 512 bytes or any other data size from the uncompressed data size.

In certain examples, software requests compression on memory pages that are being live-migrated (e.g., perceived as live to a human) to another node or perform compression on file-system blocks that are being written to the storage (e.g., disk). In certain of such scenarios, input buffers consist of a set of scattered memory pages, but software would prefer the output to be a compressed stream (e.g., into memory 108 in FIG. 1). In certain cases, software would like to also embed metadata associated with each compressed page. In one example, software achieves this by compressing each page (e.g., by processor core (e.g., central processing unit (CPU)) or through an accelerator offload) one after another and then assembling/packing a compressed stream (e.g., with required metadata as appropriate). However, in certain examples such an approach is not performant due to overheads associated with going back-and-forth to an accelerator for each memory page and overheads associated with memory copies to assemble/pack compressed stream.

Examples herein overcome these problems, for example, by utilizing the hardware and/or software extensions discussed herein to enable efficient offload of streaming operations, e.g., by allowing a single descriptor to cause multiple operations. Examples herein are directed to methods and apparatuses for accelerating streaming data-transformation operations. Examples herein reduce software overhead and improve performance of streaming data-transformation operations through the first-class and/or mainline support for a “streaming descriptor” on accelerators. Examples herein are directed to hardware and a format of a streaming descriptor for a device, e.g., accelerator. Examples herein submit a single job (e.g., via a single descriptor) to an accelerator, e.g., in contrast to submitting multiple jobs to an accelerator, e.g., and software patching/packing for streaming data usages (e.g., live-migration, file-system compression, etc.). Examples herein thus avoid or minimize software complexity and/or latency/performance overheads associated with submitting multiple jobs to an accelerator, e.g., and software-based patching/packing.

Examples herein introduce a streaming descriptor, e.g., with the support for scatter-gather and/or auto-indexing on I/O buffers. Examples herein introduce hardware (e.g., hardware agents) such as a disperser (e.g., and accumulator) that efficiently processes the streaming descriptor. Examples herein provide the functionality to insert metadata in the hardware generated output stream to reduce overheads associated with the software packing/patching. Examples herein provide the functionality to insert additional values (e.g., additional form the actual result of the accelerator's data-transformation operation) in the output (e.g., output data stream).

Examples herein provide for latency/performance enhancements for accelerators supporting data-transformation operations (e.g., compression, decompression, delta-record creation/merge, etc.), for example, those used in cloud and/or enterprise segments (e.g., live-migration, file-system compression, etc.).

An example memory related usage for accelerators is (e.g., DRAM) memory tiering via compression, e.g., to provide fleetwide memory savings via page compression. In certain examples, this is done by an (e.g., supervisor level) operating system (OS) (or virtual machine monitor (VMM) or hypervisor) transparent to (e.g., user level) applications where system software tracks memory blocks (e.g., memory pages) that are frequently accessed (e.g., “hot”) and infrequently accessed (e.g., “cold”) (e.g., according to a hot/cold timing threshold(s) and a time elapsed since a block has been accessed), and compresses infrequently accessed (e.g., “cold”) blocks (e.g., pages) into a compressed region of memory. In certain examples, when software attempts to access a block (e.g., page) of memory that is indicated as being infrequently accessed (e.g., “cold”), this results in a (e.g., page) fault, and the OS fault handler determines that a compressed version exists in the compressed region of memory (e.g., the special (e.g., “far”) tier memory region), and in response, then submits a job (e.g., a corresponding descriptor) to a hardware accelerator (e.g., depicted in FIG. 1) to decompress this block (e.g., page) of memory (e.g., and cause that uncompressed data to be stored in the near memory (e.g., DRAM)).

Turning now to FIG. 1, an example system architecture is depicted. FIG. 1 illustrates a block diagram of a computer system 100 including a plurality of cores 102-0 to 102-N (e.g., where N is any positive integer greater than one, although single core examples may also be utilized), a memory 108, and an accelerator 144 including a work dispatcher circuit 136 according to examples of the disclosure. In certain examples, an accelerator 144 includes a plurality of work execution circuits 106-0 to 106-N (e.g., where N is any positive integer greater than one, although single work execution circuit examples may also be utilized).

Memory 102 may include operating system (OS) and/or virtual machine monitor code 110, user (e.g., program) code 112, uncompressed data (e.g., pages) 114, compressed data (e.g., pages) 116 or any combination thereof. In certain examples of computing, a virtual machine (VM) is an emulation of a computer system. In certain examples, VMs are based on a specific computer architecture and provide the functionality of an underlying physical computer system. Their implementations may involve specialized hardware, firmware, software, or a combination. In certain examples, the virtual machine monitor (VMM) (also known as a hypervisor) is a software program that, when executed, enables the creation, management, and governance of VM instances and manages the operation of a virtualized environment on top of a physical host machine. A VMM is the primary software behind virtualization environments and implementations in certain examples. When installed over a host machine (e.g., processor) in certain examples, a VMM facilitates the creation of VMs, e.g., each with separate operating systems (OS) and applications. The VMM may manage the backend operation of these VMs by allocating the necessary computing, memory, storage, and other input/output (I/O) resources, such as, but not limited to, an input/output memory management unit (IOMMU). The VMM may provide a centralized interface for managing the entire operation, status, and availability of VMs that are installed over a single host machine or spread across different and interconnected hosts.

Memory 108 may be memory separate from a core and/or accelerator. Memory 108 may be DRAM. Compressed data 116 may be stored in a first memory device (e.g., far memory 146) and/or uncompressed data 114 may be stored in a separate, second memory device (e.g., as near memory). Compressed data 116 and/or uncompressed data 114 may be in a different computer system 100, e.g., as accessed via network interface controller.

A coupling (e.g., input/output (I/O) fabric interface 104) may be included to allow communication between accelerator 144, core(s) 102-0 to 102-N, memory 108, network interface controller 150, or any combination thereof.

In one example, the hardware initialization manager (non-transitory) storage 118 stores hardware initialization manager firmware (e.g., or software). In one example, the hardware initialization manager (non-transitory) storage 118 stores Basic Input/Output System (BIOS) firmware. In another example, the hardware initialization manager (non-transitory) storage 118 stores Unified Extensible Firmware Interface (UEFI) firmware. In certain examples (e.g., triggered by the power-on or reboot of a processor), computer system 100 (e.g., core 102-0) executes the hardware initialization manager firmware (e.g., or software) stored in hardware initialization manager (non-transitory) storage 118 to initialize the system 100 for operation, for example, to begin executing an operating system (OS) and/or initialize and test the (e.g., hardware) components of system 100.

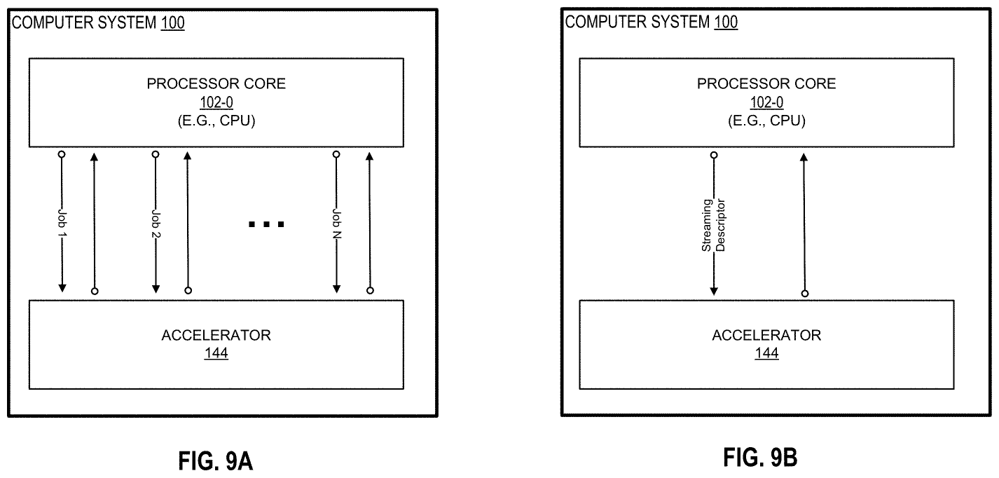

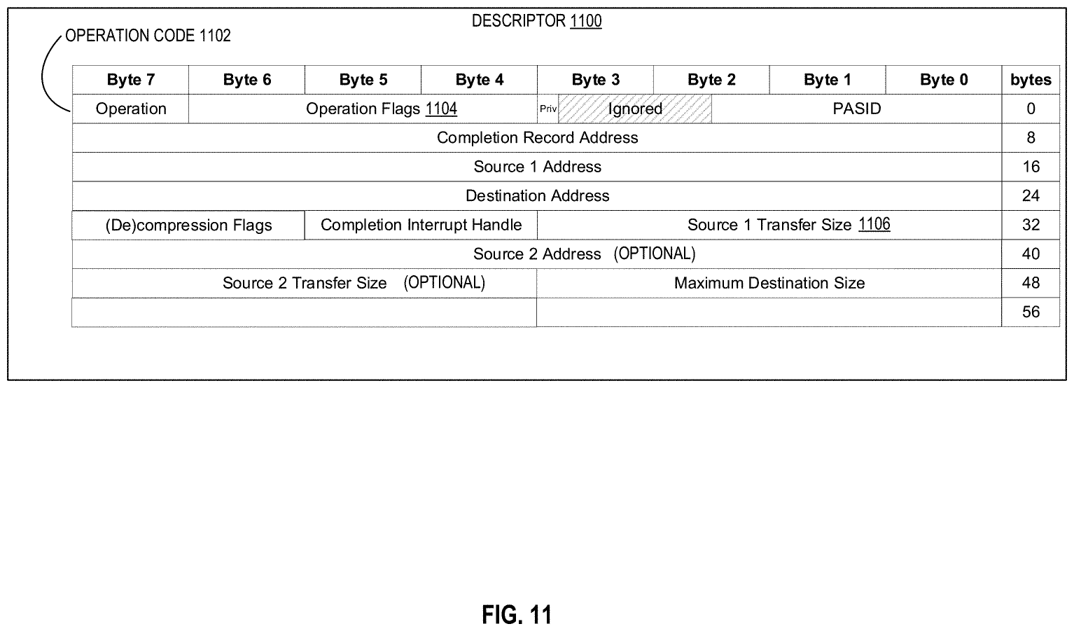

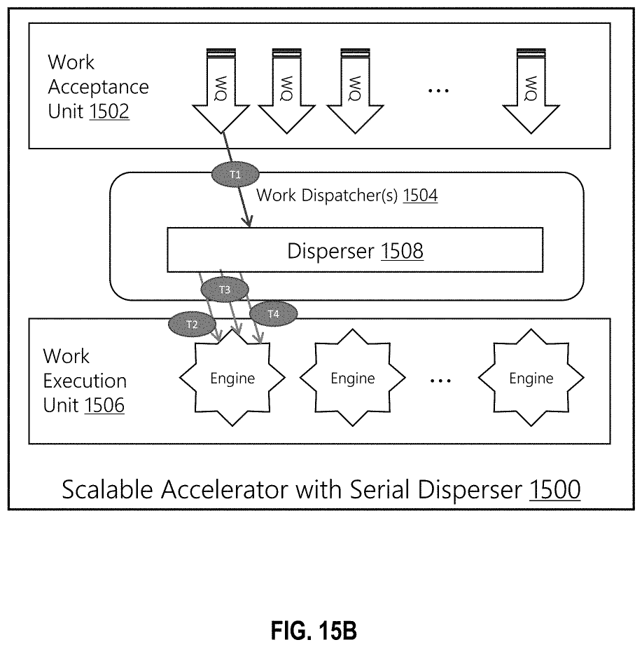

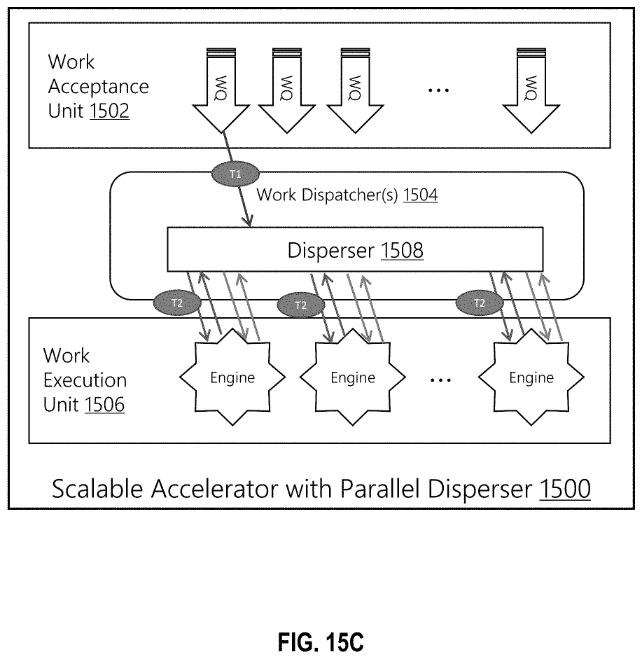

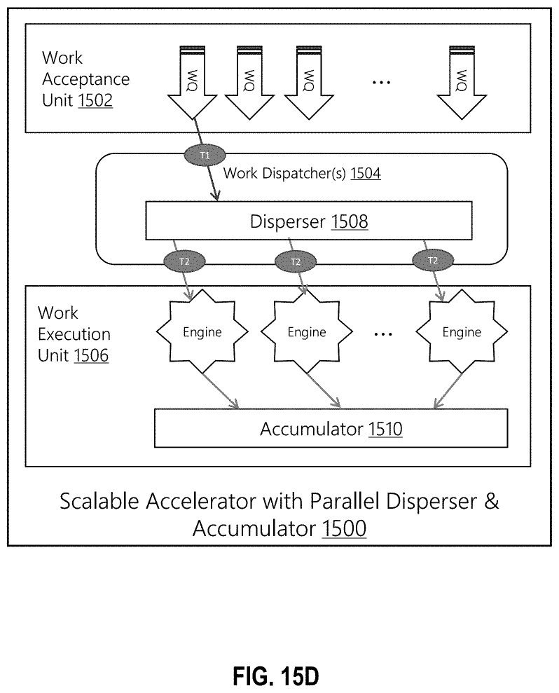

An accelerator 144 may include any of the depicted components. For example, with one or more instance of a work execution circuit 106-0 to 106-N. In certain examples, a job (e.g., corresponding descriptor for that job) is submitted to the accelerator 144 via the work queues 140-0 to 140-M, e.g., where M is any positive integer greater than one, although work queue examples may also be utilized). In one example, the number of work queues is the same as the number of work engines (e.g., work execution circuits). In certain examples, an accelerator configuration 120 (e.g., configuration value stored therein) causes accelerator 144 to be configured to perform one or more (e.g., decompression or compression) operations. In certain examples, work dispatcher circuit 136 (e.g., in response to descriptor and/or accelerator configuration 120) selects a job from a work queue and submits it to a work execution circuit 106-0 to 106-N for one or more operations. In certain examples, a single descriptor is sent to accelerator 144 that indicates the requested operation(s) include a plurality of jobs (e.g., sub-jobs) that are to be performed by the accelerator 144, e.g., by one or more of the work execution circuits 106-0 to 106-N. In certain examples, the single descriptor (e.g., according to the format depicted in FIG. 11) causes the work dispatcher circuit 136 to (i) when a field of the single descriptor is a first value, send a single job to a single work execution circuit of the one or more work execution circuits 106-0 to 106-N to perform an operation indicated in the single descriptor to generate an output, and/or (ii) when the field of the single descriptor is a second different value, send a plurality of jobs to the one or more work execution circuits 106-0 to 106-N to perform the operation indicated in the single descriptor to generate the output (e.g., as a single stream). In certain examples, the accelerator 144 (e.g., work dispatcher circuit 136) includes a disperser 138 (e.g., disperser circuit) to disperse the plurality of jobs requested by the single descriptor to one or more of the work execution circuits 106-0 to 106-N, e.g., as discussed in reference to FIGS. 15A-15D. In certain examples, having a single descriptor that indicates a plurality of jobs is different than submitting multiple descriptors at once (for example, multiple descriptors indicated by a batch descriptor, e.g., that contains the address of an array of work descriptors). In certain examples, having a single descriptor that indicates multiple jobs (e.g., sub-jobs) is an improvement of utilizing multiple descriptors for similar operations, for example, avoiding the latency and communication resource consumption used to send multiple jobs and requests between a core and accelerator, e.g., as discussed in reference to FIGS. 9A-9B.

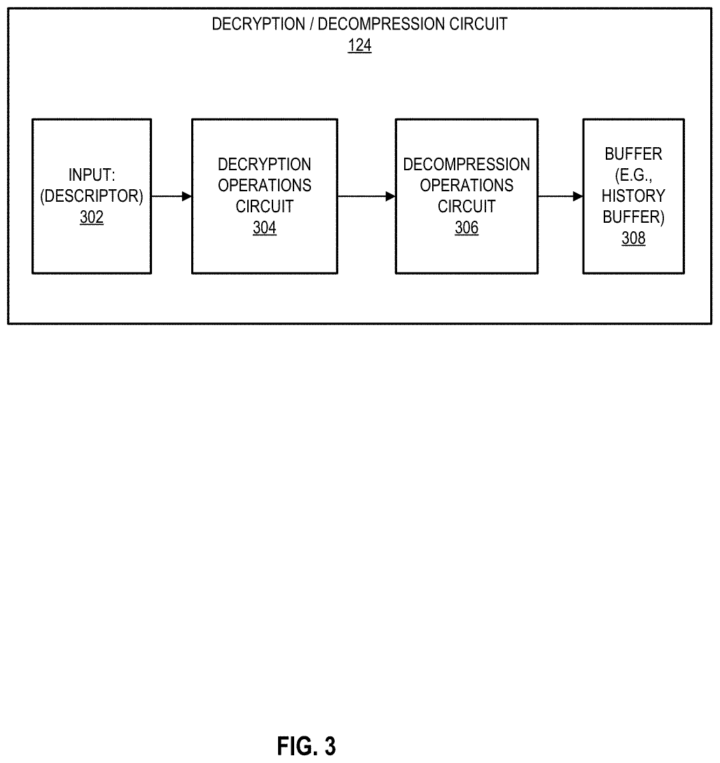

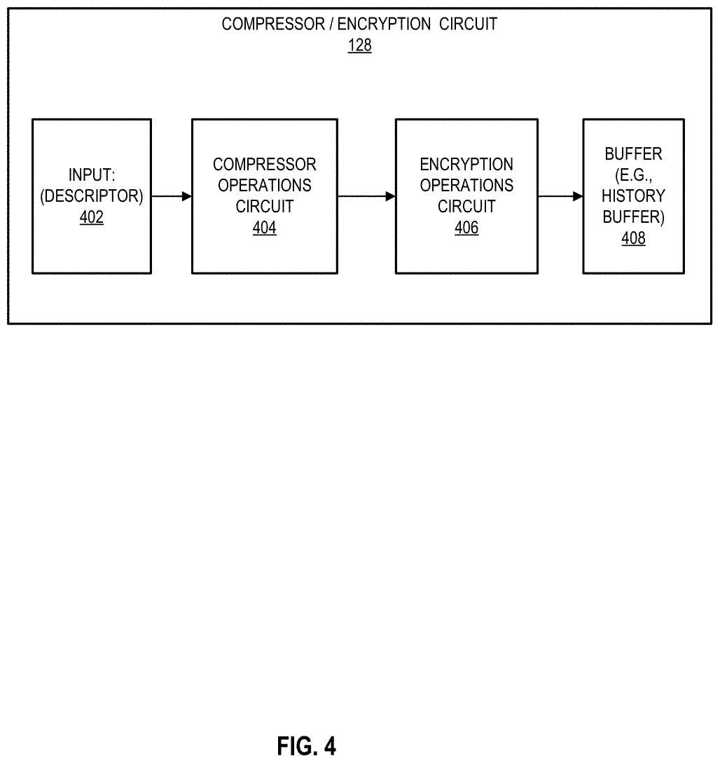

In the depicted example, a (e.g., each) work execution circuit 106-0 to 106-N includes a decompressor circuit 124 to perform decompression operations (see, e.g., FIG. 3), a compressor circuit 128 to perform compression operations (see, e.g., FIG. 4), and a direct memory access (DMA) circuit 122, e.g., to connect to memory 108, internal memory (e.g., cache) of a core, and/or far memory 146. In one example, compressor circuit 128 is (e.g., dynamically) shared by two or more of the work execution circuits 106-0 to 106-N. In certain examples, the data for a job that is assigned to a particular work execution circuit (e.g., work execution circuit 106-0) is streamed in by DMA circuit 122, for example, as primary and/or secondary input. Multiplexers 126 and 132 may be utilized to route data for a particular operation. Optionally, a (e.g., Structured Query Language (SQL)) filter engine 130 may be included, for example, to perform a filtering query (e.g., for a search term input on the secondary data input) on input data, e.g., on decompressed data output from decompressor circuit 124.

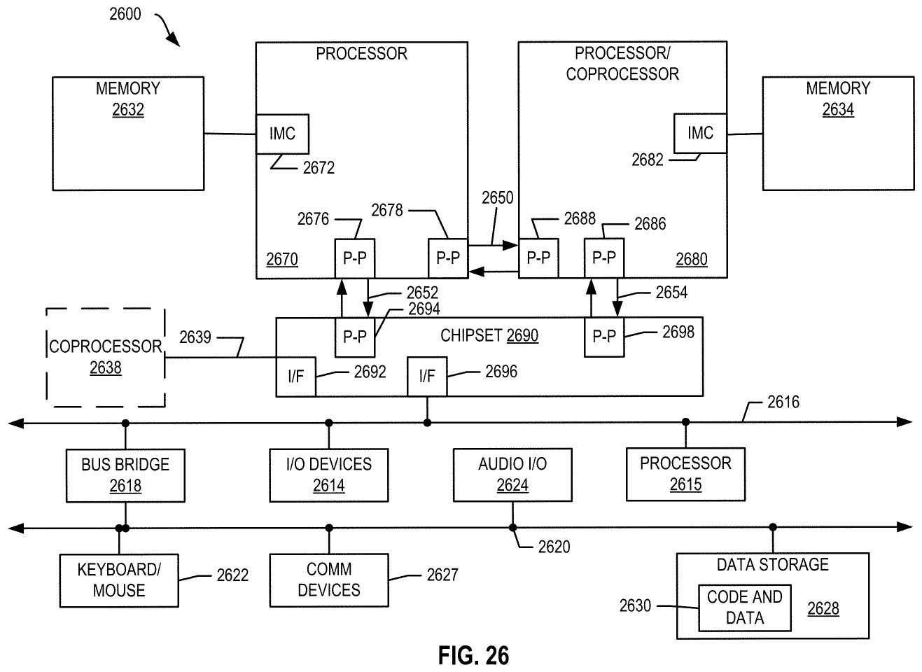

In certain examples, work dispatcher circuit maps a particular job (e.g., or a corresponding plurality of jobs for a single descriptor) to a particular work execution circuit 106-0 to 106-N. In certain examples, each work queue 140-0 to 140-M includes an MMIO port 142-0 to 142-N, respectively. In certain examples, a core sends a job (e.g., a descriptor) to accelerator 144 via one or more of the MMIO ports 142-0 to 142-N. Optionally, an address translation cache (ATC) 134 may be included, e.g., as a TLB to translate a virtual (e.g., source or destination) address to a physical address (e.g., in memory 108 and/or far memory 146). As discussed below, accelerator 144 may include a local memory 148, e.g., shared by a plurality of work execution circuits 106-0 to 106-N. Computer system 100 may couple to a hard drive, e.g., storage unit 2628 in FIG. 26.

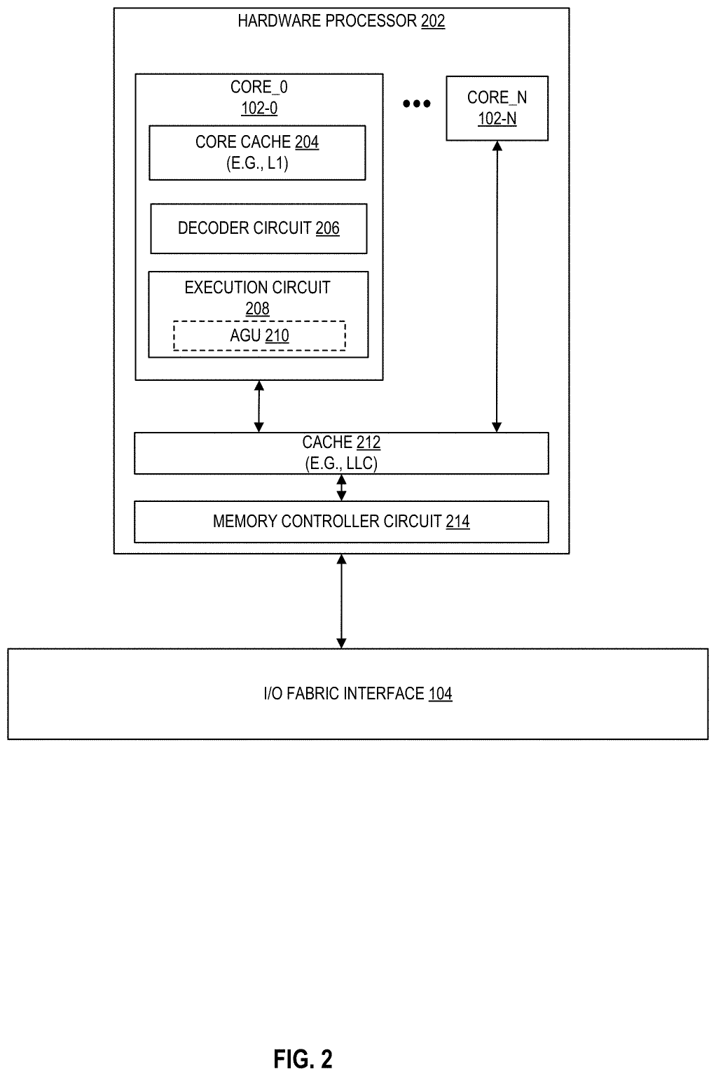

FIG. 2 illustrates a block diagram of a hardware processor 202 including a plurality of cores 102-0 to 102-N according to examples of the disclosure. Memory access (e.g., store or load) request may be generated by a core, e.g., a memory access request may be generated by execution circuit 208 of core 102-0 (e.g., caused by the execution of an instruction) and/or a memory access request may be generated by execution circuit of core 102-N (e.g., by address generation unit 210 thereof) (e.g., caused by a decode by decoder circuit 206 of an instruction and the execution of the decoded instruction). In certain examples, a memory access request is serviced by one or more levels of cache, e.g., core (e.g., first level (L1)) cache 204 for core 102-0 and a cache 212 (e.g., last level cache (LLC)), e.g., shared by a plurality of cores. Additionally or alternatively (e.g., for a cache miss), memory access request may be serviced by memory separate from a cache, e.g., but not a disk drive.

In certain examples, hardware processor 202 includes a memory controller circuit 214. In one example, a single memory controller circuit is utilized for a plurality of cores 102-0 to 102-N of hardware processor 202. Memory controller circuit 214 may receive an address for a memory access request, e.g., and for a store request also receiving the payload data to be stored at the address, and then perform the corresponding access into memory, e.g., via I/O fabric interface 104 (e.g., one or more memory buses). In certain examples, memory controller 214 includes a memory controller for volatile type of memory 108 (e.g., DRAM) and a memory controller for non-volatile type of far memory 146 (e.g., non-volatile DIMM or non-volatile DRAM). Computer system 100 may also include a coupling to secondary (e.g., external) memory (e.g., not directly accessible by a processor), for example, a disk (or solid state) drive (e.g., storage unit 2628 in FIG. 26).

As noted above, an attempt to access a memory location may indicate that the data to be accessed is not available, e.g., a page miss. Certain examples herein then trigger a decompressor circuit to perform a decompression operation (e.g., via a corresponding descriptor) on the compressed version of that data, e.g., to service the miss with the decompressed data within a single computer.

FIG. 3 is a block flow diagram of a decryption/decompression circuit 124 according to examples of the disclosure. In certain examples, decryption/decompression circuit 124 takes as an input a descriptor 302 (e.g., operation indicated in the descriptor), decryption operations circuit 304 performs decryption on the compressed data identified in the descriptor, decompression operations circuit 306 performs decompression on the decrypted compressed data identified in the descriptor, and then stores that data within buffer 308 (e.g., history buffer). In certain examples, the buffer 308 is sized to store all the data from a single decompression operation.

FIG. 4 is a block flow diagram of a compressor/encryption circuit 128 according to examples of the disclosure. In certain examples, compressor/encryption circuit 128 takes as an input a descriptor 402 (e.g., operation indicated in the descriptor), compressor operations circuit 404 performs compression on the input data identified in the descriptor, encryption operations circuit 406 performs encryption on the compressed data identified in the descriptor, and then stores that data within buffer 408 (e.g., history buffer). In certain examples, the buffer 408 is sized to store all the data from a single compression operation.

Turning to FIGS. 1 and 3 cumulatively, as one example use, a (e.g., decompression) operation is desired (e.g., on data that missed in a core and is to be loaded from far memory 146 into uncompressed data 114 in memory 108 and/or into one or more cache levels of a core), and a corresponding descriptor is sent to accelerator 144, e.g., into a work queue 140-0 to 140-M. In certain examples, that descriptor is then picked up by work dispatcher circuit 136 and the corresponding job(s) (e.g., plurality of sub-jobs) is sent to one of the work execution circuits 106-0 to 106-N (e.g., engines), for example, which are mapped to different compression and decompression pipelines. In certain examples, the engine will start reading the source data from the source address (e.g., in compressed data 116) specified in the descriptor, and the DMA circuit 122 will send a stream of input data into the decompressor circuit 124.

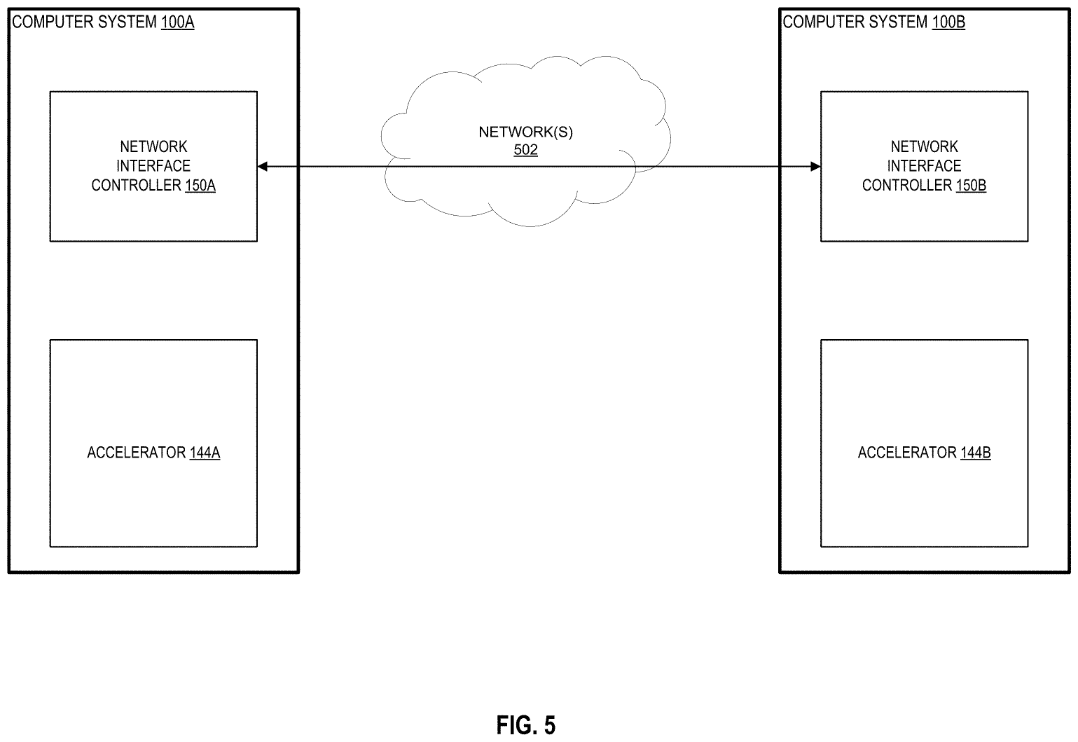

FIG. 5 is a block diagram of a first computer system 100A (e.g., as a first instance of computer system 100 in FIG. 1) coupled to a second computer system 100B (e.g., as a second instance of computer system 100 in FIG. 1) via one or more networks 502 according to examples of the disclosure. In certain examples, data is transferred between first computer system 100A and computer system 100B via their respective network interface controllers 150A-150B. In certain examples, accelerator 144A is to send its output to computer system 100B, e.g., accelerator 144B thereof, and/or accelerator 144B is to send its output to computer system 100A, e.g., accelerator 144A thereof.

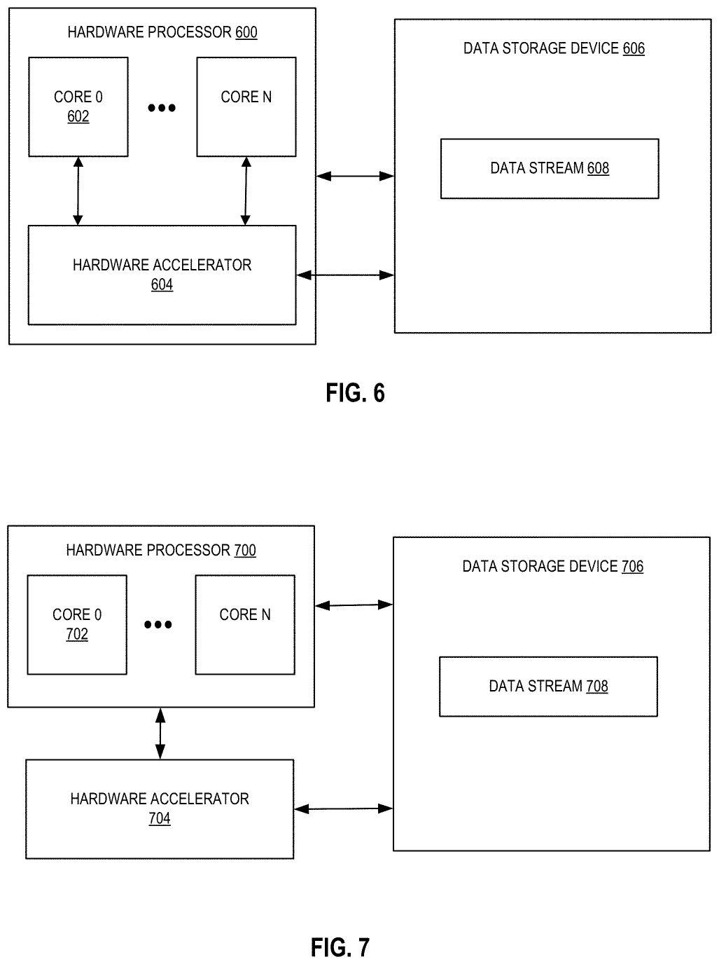

FIG. 6 illustrates a block diagram of a hardware processor 600 having a plurality of cores 0 (602) to N and a hardware accelerator 604 coupled to a data storage device 606 according to examples of the disclosure. Hardware processor 600 (e.g., core 602) may receive a request (e.g., from software) to perform a decryption and/or decompression thread (e.g., operation) and may offload (e.g., at least part of) the decryption and/or decompression thread (e.g., operation) to a hardware accelerator (e.g., hardware decryption and/or decompression accelerator 604). Hardware processor 600 may include one or more cores (0 to N). In certain examples, each core may communicate with (e.g., be coupled to) hardware accelerator 604. In certain examples, each core may communicate with (e.g., be coupled to) one of multiple hardware accelerators. Core(s), accelerator(s), and data storage device 606 may communicate (e.g., be coupled) with each other. Arrows indicate two-way communication (e.g., to and from a component), but one way communication may be used. In certain examples, a (e.g., each) core may communicate (e.g., be coupled) with the data storage device, for example, storing and/or outputting a data stream 608. Hardware accelerator may include any hardware (e.g., circuit or circuitry) discussed herein. In certain examples, an (e.g., each) accelerator communicates (e.g., is coupled) with the data storage device, for example, to receive an encrypted, compressed data stream.

FIG. 7 illustrates a block diagram of a hardware processor 700 having a plurality of cores 0 (702) to N coupled to a data storage device 706 and to a hardware accelerator 704 coupled to the data storage device 706 according to examples of the disclosure. In certain examples, a hardware (e.g., decryption and/or decompression) accelerator is on die with a hardware processor. In certain examples, a hardware (e.g., decryption and/or decompression) accelerator is off die of a hardware processor. In certain examples, system including at least a hardware processor 700 and a hardware (e.g., decryption and/or decompression) accelerator 704 are a system on a chip (SoC). Hardware processor 700 (e.g., core 702) may receive a request (e.g., from software) to perform a decryption and/or decompression thread (e.g., operation) and may offload (e.g., at least part of) the decryption and/or decompression thread (e.g., operation) to a hardware accelerator (e.g., hardware decryption and/or decompression accelerator 704). Hardware processor 700 may include one or more cores (0 to N). In certain examples, each core may communicate with (e.g., be coupled to) hardware (e.g., decryption and/or decompression) accelerator 704. In certain examples, each core may communicate with (e.g., be coupled to) one of multiple hardware decryption and/or decompression accelerators. Core(s), accelerator(s), and data storage device 706 may communicate (e.g., be coupled) with each other. Arrows indicate two-way communication (e.g., to and from a component), but one way communication may be used. In certain examples, a (e.g., each) core may communicate (e.g., be coupled) with the data storage device, for example, storing and/or outputting a data stream 708. Hardware accelerator may include any hardware (e.g., circuit or circuitry) discussed herein. In certain examples, an (e.g., each) accelerator may communicate (e.g., be coupled) with the data storage device, for example, to receive an encrypted, compressed data stream. Data stream 708 (e.g., encoded, compressed data stream) may be previously loaded into data storage device 706, e.g., by a hardware compression accelerator or a hardware processor.

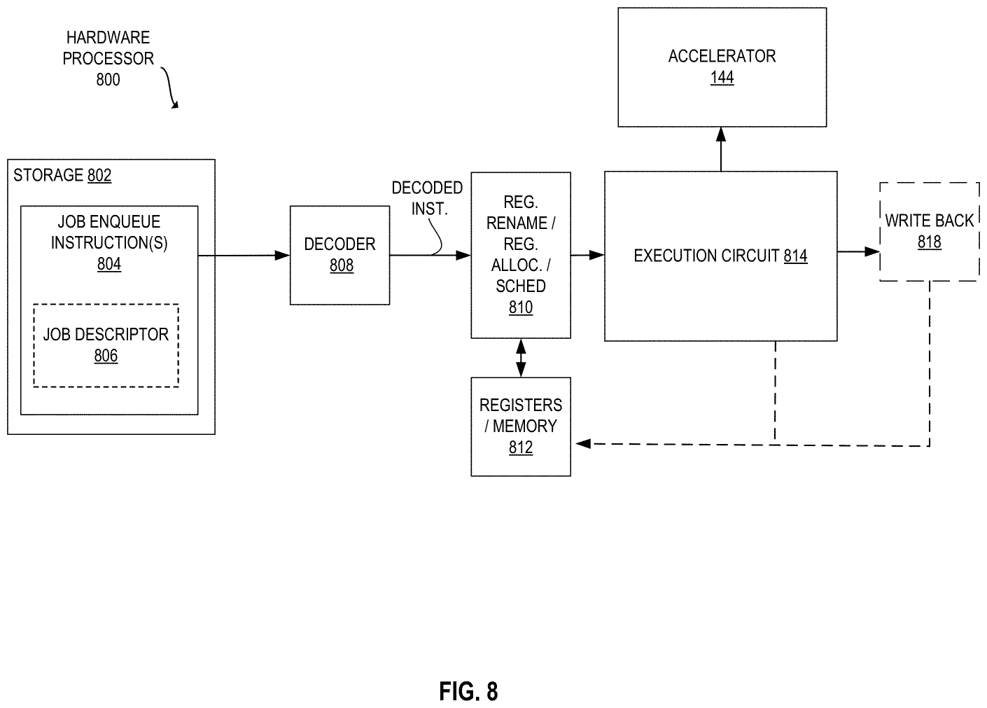

FIG. 8 illustrates a hardware processor 800 coupled to storage 802 that includes one or more job enqueue instructions 804 according to examples of the disclosure. In certain examples, job enqueue instruction is according to any of the disclosure herein. In certain examples, job enqueue instruction 804 identifies a (e.g., single) job descriptor 806 (e.g., and the (e.g., logical) MMIO address of an accelerator.

In certain examples, e.g., in response to a request to perform an operation, the instruction (e.g., macro-instruction) is fetched from storage 802 and sent to decoder 808. In the depicted example, the decoder 808 (e.g., decoder circuit) decodes the instruction into a decoded instruction (e.g., one or more micro-instructions or micro-operations). The decoded instruction is then sent for execution, e.g., via scheduler circuit 810 to schedule the decoded instruction for execution.

In certain examples, (e.g., where the processor/core supports out-of-order (OoO) execution), the processor includes a register rename/allocator circuit 810 coupled to register file/memory circuit 812 (e.g., unit) to allocate resources and perform register renaming on registers (e.g., registers associated with the initial sources and final destination of the instruction). In certain examples, (e.g., for out-of-order execution), the processor includes one or more scheduler circuits 810 coupled to the decoder 808. The scheduler circuit(s) may schedule one or more operations associated with decoded instructions, including one or more operations decoded from a job enqueue instruction 804, e.g., for offloading execution of an operation to accelerator 144 by the execution circuit 814.

In certain examples, a write back circuit 818 is included to write back results of an instruction to a destination (e.g., write them to a register(s) and/or memory), for example, so those results are visible within a processor (e.g., visible outside of the execution circuit that produced those results).

One or more of these components (e.g., decoder 808, register rename/register allocator/scheduler 810, execution circuit 814, registers (e.g., register file)/memory 812, or write back circuit 818) may be in a single core of a hardware processor (e.g., and multiple cores each with an instance of these components).

In certain examples, operations of a method for processing a job enqueue instruction include (e.g., in response to receiving a request to execute an instruction from software) processing a “job enqueue” instruction by performing a fetch of an instruction (e.g., having an instruction opcode corresponding to the job enqueue mnemonic), decode of the instruction into a decoded instruction, retrieve data associated with the instruction, (optionally) schedule the decoded instruction for execution, execute the decoded instruction to enqueue a job in an work execution circuit, and commit a result of the executed instruction.

### Streaming Descriptor

FIG. 9A illustrates a block diagram of a computer system 100 including a processor core 102-0 sending a plurality of jobs (e.g., and thus a plurality of corresponding descriptors) to an accelerator according to examples of the disclosure.

FIG. 9B illustrates a block diagram of a computer system 100 including a processor core 102-0 sending a single (e.g., streaming) descriptor for a plurality of jobs to an accelerator according to examples of the disclosure.

Thus, examples herein allow a single descriptor to communicate information to an accelerator about multiple jobs (e.g., mini-jobs) through a streaming descriptor. Certain examples herein utilize a streaming descriptor hardware extension to allow software to create and submit the streaming descriptor to the accelerator. In certain examples, streaming descriptor represents a stream/cumulation of individual jobs (e.g., work-items or mini-jobs) and thus removes the need of going back-and-forth to an accelerator, e.g., as in FIG. 9A.

In certain examples, the streaming descriptor hardware extension allows software to send a plurality of pages of data in memory to be processed (e.g., compressed) via a single descriptor, e.g., while also treating each of them as independent/mini compression jobs.

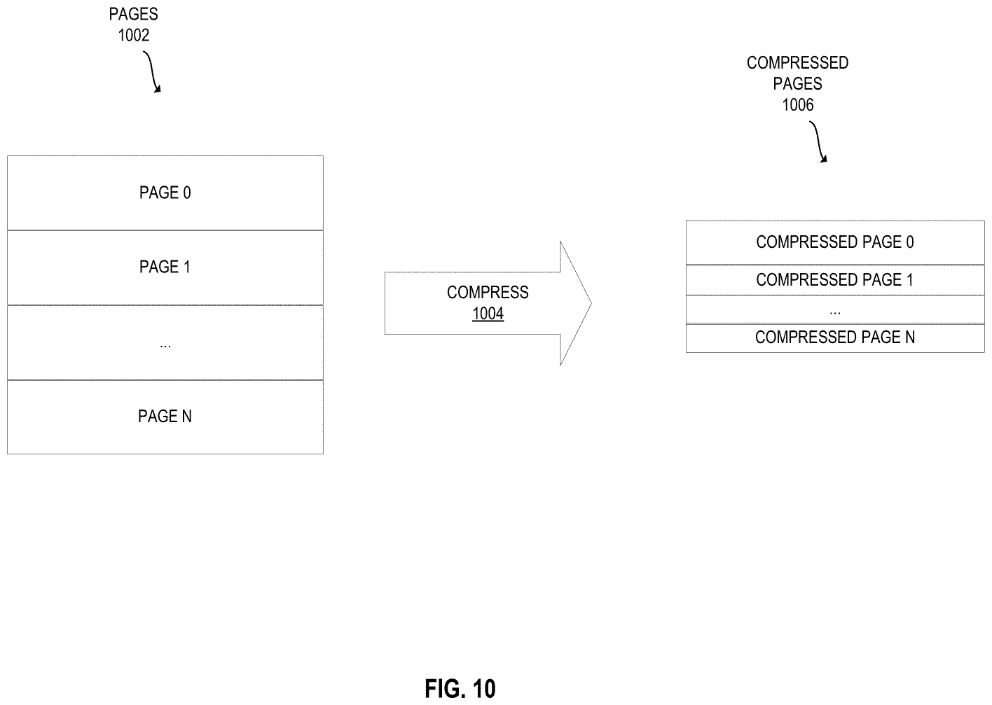

FIG. 10 is a block flow diagram of a compression operation 1004 on a plurality of contiguous memory pages 1002 according to examples of the disclosure. In certain examples, compression operation 1004 produces a plurality of corresponding compressed versions 1006 of pages 1002. In certain examples, a single descriptor causes the operations in FIG. 10 to be performed by an accelerator. In certain examples, the output 1006 is a continuous stream of data corresponding to the compressed pages.

In certain examples, each job (e.g., mini-job) performs (e.g., compression or decompression) operations on a corresponding chunk of the input data. In certain examples, since each of these chunks are compressed independently, they can also be decompressed independently of each other. Such an approach improves performance for live-migration of data (e.g., from first computer system 100A to second computer system 100B in FIG. 5 or vice-versa), e.g., where software would like to decompress a page and populate memory as soon as a network packet (e.g., chunk of data) is received and/or for file-system compression scenarios where software would like to access random portions of a file (e.g., disk).

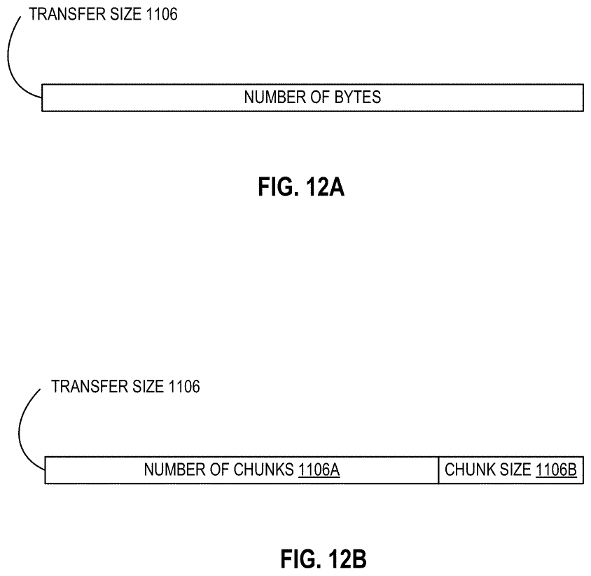

FIG. 11 illustrates an example format 1100 of a descriptor (e.g., work descriptor) according to examples of the disclosure. Descriptor 1100 may include any of the depicted fields, for example, with PASID being Process Address Space ID, for example, to identify a particular address space, e.g., process, virtual machine, container, etc. In certain examples, operation code in field 1102 is a value that indicates an (e.g., decryption and/or decompression) operation where a single descriptor 1100 identifies the source address and/or the destination address. In certain examples, a field of the descriptor 1100 (e.g., one or more flags 1104) indicate functionality to be used for the corresponding operation, for example, as discussed in reference to FIGS. 12A-17C. In certain examples, one of the fields (e.g., flag(s) 1104) (e.g., when set to a certain value) cause a plurality of jobs to be sent by a work dispatcher circuit to one or more work execution circuits to perform an operation indicated by the field 1102 in the single descriptor to generate an output, e.g., as a single stream.

In certain examples, the descriptor 1100 includes a field 1106 to indicate the transfer size, e.g., the total size of the input data. In certain examples, the transfer size field is selectable between two different formats, for example, between (i) the number of bytes and (ii) the number (e.g., and size) of chunks. In certain examples, the descriptor 1100 indicates the format of the transfer size field, e.g., via a corresponding one of flag(s) 1104. In certain examples, hardware (e.g., an accelerator) interprets the transfer size field 1106 based on the transfer size type selector specified in the descriptor.

FIG. 12A illustrates an example “number of bytes” format of a transfer size field 1106 of a descriptor according to examples of the disclosure. In certain examples, an accelerator is to perform its operations on a total amount of data as indicated by a value stored in the transfer size field 1106 in “number of bytes”, e.g., with that value being selected during creation of the descriptor.

FIG. 12B illustrates an example “chunk” format of a transfer size field 1106 of a descriptor according to examples of the disclosure. In certain examples, an accelerator is to perform its operations on one or more chunks of data indicated by a first value stored in the number of chunks field 1106A of the transfer size field 1106 in “chunk” format (e.g., and a chunk size indicated by a second value stored in the chunk size field 1106B of the transfer size field 1106 in “chunk” format), e.g., with that value (or values) being selected during creation of the descriptor.

In certain examples for transfer size field 1106 in “chunk” format, a software configures “source 1 address” to point to a block of pages with a number of chunks set to N (e.g., selected as an integer greater than zero) and a chunk-size set to a page size or otherwise, e.g., set to 4K or a decoding conveying 4K size. Depending upon the scenario and/or IOMMU configuration, the address(es) in the descriptor could be a virtual address or a physical address in certain examples.

In certain examples, the input/output (e.g., buffer) addresses are (i) auto-incremented by the chunk-size or (ii) offset by the chunk-size multiplied by the chunk-index at the end of an individual job, e.g., of a plurality of jobs (e.g., work-item/mini-job). However, in other examples, it is incremented based on the execution outcome of an individual job e.g., of a plurality of jobs (e.g., work-item/mini-job). For example, in the compression scenario discussed above, in certain examples the input buffer will be auto-incremented or offset, however given the compression operation is data-dependent and output-size is not known upfront, it will use specific serialization or accumulation to maintain streaming semantics for the output buffer.

Examples herein (e.g., for transfer size field 1106 in “chunk” format) remove the need to go back-and-forth to an accelerator and/or remove memory copies associated with creating a contiguous output stream. However, in certain examples, if the pages are scattered in memory, the software is to create a virtual/contiguous address space before issuing the work-descriptor to an accelerator and then teardown the address space once the job is complete. As a solution to this issue, certain examples herein provide a hardware extension where software has an ability to provide a streaming descriptor with a scatter-gather list to an accelerator, thereby enabling a more friendly programming model.

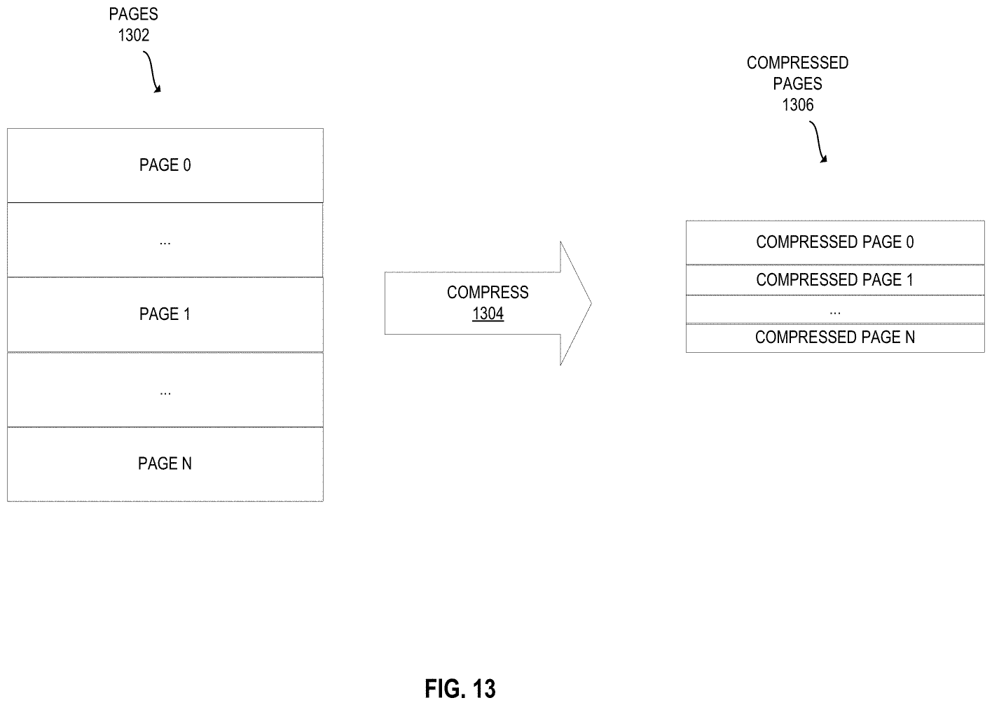

FIG. 13 is a block flow diagram of a compression operation 1304 on a plurality of non-contiguous memory pages 1302 according to examples of the disclosure. In certain examples, compression operation 1304 produces a plurality of corresponding compressed versions 1306 of pages 1302. In certain examples, a single descriptor causes the operations in FIG. 13 to be performed by an accelerator. In certain examples, the output 1306 is a continuous stream of data corresponding to the compressed pages.

In certain examples, each job (e.g., mini-job) performs (e.g., compression or decompression) operations on a corresponding chunk of the input data. In certain examples, since each of these chunks are compressed independently, they can also be decompressed independently of each other. Such an approach improves performance for live-migration of data (e.g., from first computer system 100A to second computer system 100B in FIG. 5 or vice-versa), e.g., where software would like to decompress a page and populate memory as soon as a network packet (e.g., chunk of data) is received and/or for file-system compression scenarios where software would like to access random portions of a file (e.g., disk).

In certain examples, the descriptor 1100 includes one or more fields to indicate a source (e.g., input) data address and/or a destination (e.g., output) address, e.g., “source 1 address” and “destination address”, respectively in FIG. 11. In certain examples, the source address field and/or destination address field is selectable between two different formats of address types, for example, between (i) where the value in the field(s) points to an actual source/destination (e.g., buffer) and (ii) the value in the field(s) points to one or more scatter-gather lists that contains addresses for the actual source/destination (e.g., buffers). In certain examples, the descriptor 1100 indicates the format of the address field(s), e.g., via a corresponding one or more of flag(s) 1104. In certain examples, hardware (e.g., an accelerator) interprets the address fields based on the address type selector specified in the descriptor.

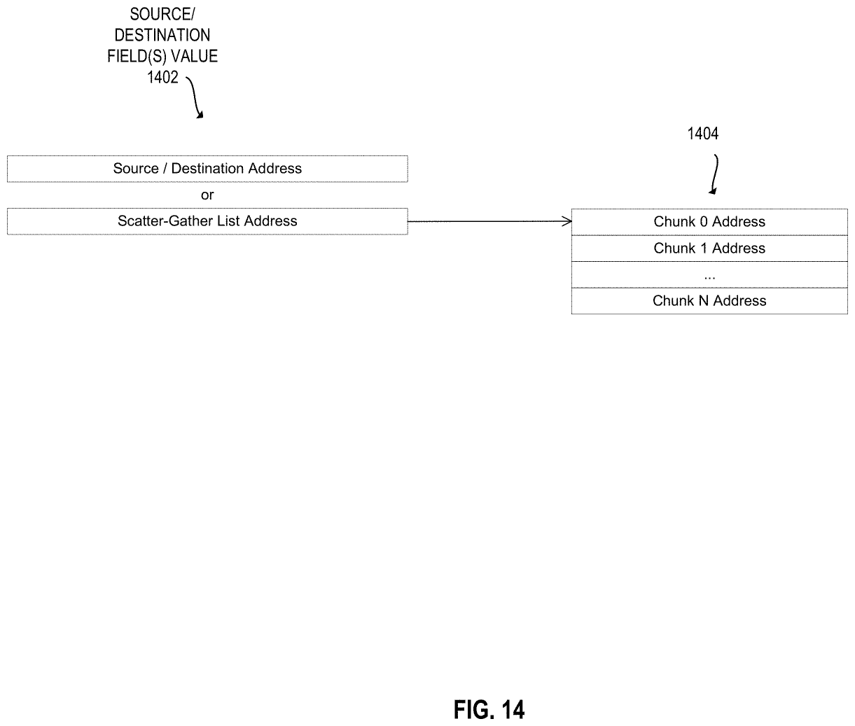

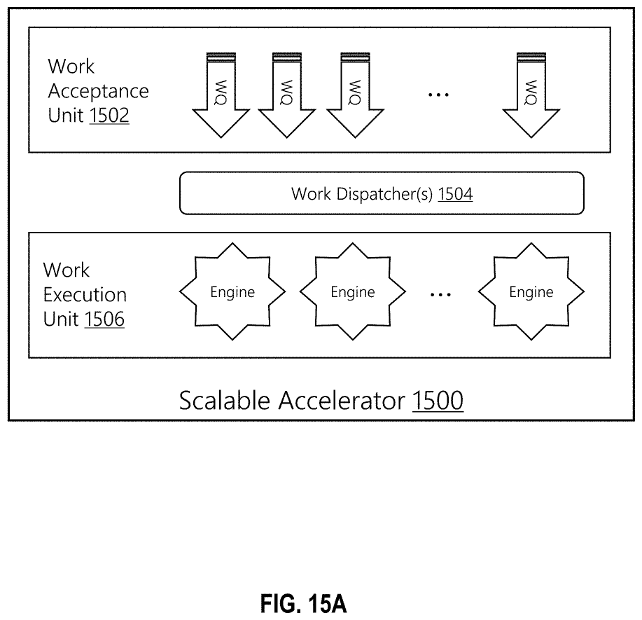

FIG. 14 illustrates an example address type format of a source and/or destination address field 1402 of a descriptor according to examples of the disclosure. In certain examples, (i) the value in the field(s) 1402 points to an actual source/destination (e.g., buffer) and (ii) the value in the field points to a scatter-gather list 1404 that contains addresses for the actual source/destination (e.g., buffers). In certain examples, the use of such a list allows for a single descriptor to be used for a plurality of (e.g., logically) non-contiguous memory locations (e.g., pages). In certain examples, each chunk is a single page of memory.

The above provides solutions to communicating multiple jobs (e.g., mini-jobs) through a streaming descriptor. The below describes accelerator architecture used to process (e.g., execute) a streaming descriptor.

### Disperser

FIG. 15A illustrates a block diagram of a scalable accelerator 1500 including a work acceptance unit 1502, a work dispatcher 1504, and a plurality of work execution engines in work execution unit 1506 according to examples of the disclosure. In certain examples, accelerator 1500 is an instance of accelerator 144 in FIG. 1, for example, where the work acceptance unit 1502 is MMIO ports 142-0 to 142-M (e.g., and the work queues (WQ) are work queues 140-0 to 140-M in FIG. 1), the work dispatcher(s) 1504 is the work dispatcher circuit 136 in FIG. 1, and the work execution unit 1506 (e.g., engines thereof) are work execution circuits 106-0 to 106-N in FIG. 1. Although a plurality of work engines are shown, certain examples may only have a single work engine. In certain examples, work acceptance unit 1502 receives a request (e.g., a descriptor), work dispatcher 1504 dispatches one or more corresponding operations (e.g., one operation for each mini-job) to one or more of the plurality of work execution engines in work execution unit 1506, and the results are generated therefrom.

When utilizing a single descriptor that indicates a plurality of jobs (e.g., “mini-jobs”), certain examples herein include a disperser (e.g., hardware agent) that is responsible for processing a streaming descriptor received in a work-queue (WQ) and dispatching it to one or more engines, e.g., in the form of mini-jobs. In certain examples, a disperser is disperser 138 (e.g., disperser circuit) in FIG. 1.

FIG. 15B illustrates a block diagram of the scalable accelerator 1500 having a serial disperser 1508 according to examples of the disclosure. In certain examples, the scalable accelerator 1500 implements a serial disperser 1508 (e.g., within a dispatcher) that waits for the completion of one job (e.g., mini-job) before it dispatches the next (e.g., mini-job) to the engine(s) (shown via timestamps at time “2” (T2), time “3” (T3), and time “4” (T4) for a request received by serial disperser 1508 at earlier time “1” (T1) in FIG. 15B). Such a “serialization” may be required for creating a contiguous compressed stream, e.g., where a second engine does not know where to start storing the output until the first engine has compressed the first page and the disperser knows the output buffer size increment as a result of the first mini-job. In certain examples, serialization is required if one mini-job would like to take output of a previous mini-job as an input.

FIG. 15C illustrates a block diagram of the scalable accelerator 1500 having a parallel disperser 1508 according to examples of the disclosure. In certain examples, the scalable accelerator 1500 implements a parallel disperser 1508 that issues an (e.g., lightweight) operation to determine mini-job parameters and then issues the actual mini jobs in parallel (shown via same timestamp T2 across all mini-jobs for a request received by serial disperser 1508 at earlier time “1” (T1) in FIGS. 15C-D). For example, as part of processing a streaming descriptor representing three compression mini-jobs, parallel disperser 1508 can first issue lightweight statistics operation to determine initial compression data (e.g., Huffman tables) and output size, and then issue the actual compression operation. In certain examples, such an approach removes the need to serialize (e.g., most) mini-jobs (e.g., unless they have dependencies on each other) and would significantly improve overall performance through the parallelization.

FIG. 15D illustrates a block diagram of the scalable accelerator 1500 having the parallel disperser 1508 and an accumulator 1510 (e.g., accumulator circuit) according to examples of the disclosure. In certain examples, the parallel disperser 1508 parallelly issue mini-jobs across engines and then the accumulator 1510 accumulates and packs the output from different engines into a contiguous stream. Such a scalable accelerator may make use of internal storage (e.g., SRAM, registers, etc.) or some context/staging buffer located in device/system-memory to temporarily maintain transient state or data produced by engines for accumulator to later accumulate (e.g., and pack) it as desired.

### Embedding Data in an Output Stream

Certain data-transformation operations will benefit if an accelerator has the ability to insert data into an output stream, e.g., to tag metadata associated with a mini job alongside the corresponding output. For example, when live-migrating a set of memory pages, it may be useful to have a metadata that provides the cyclic redundancy check (CRC) value (e.g., code) associated with each chunk (e.g., page), the size of compressed data, padding, placeholder, etc. In certain examples, the descriptor 1100 in FIG. 11 indicates data is to be inserted into the output stream (e.g., separately for each corresponding chunk in the output) (e.g., on a one-to-one basis), e.g., via setting a corresponding one or more of flag(s) 1104.

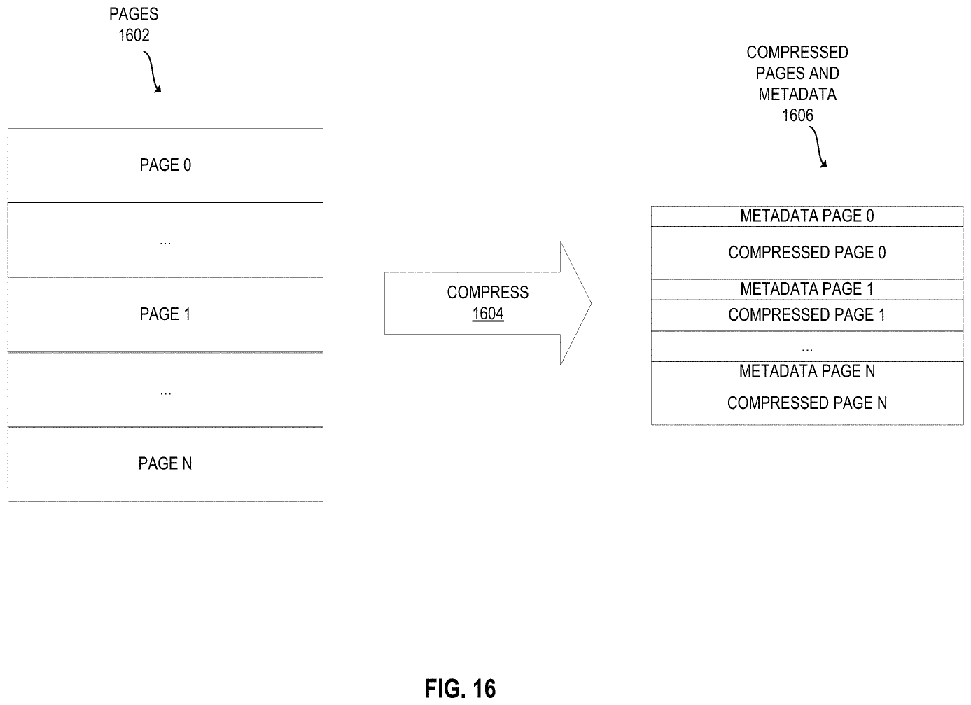

FIG. 16 is a block flow diagram of a compression operation 1604 on a plurality of (e.g., non-contiguous) memory pages 1602 that generates metadata for each compressed page according to examples of the disclosure. In certain examples, compression operation 1604 produces a plurality of corresponding compressed versions 1606 of pages 1602 and corresponding metadata. In certain examples, a single descriptor causes the operations in FIG. 16 to be performed by an accelerator. In certain examples, the output 1606 is a continuous stream of data corresponding to the compressed pages and metadata.

In certain examples, an accelerator allows software to enable metadata tagging by setting a corresponding flag in the descriptor. In certain examples, an accelerator allows software to pick and choose one or more specific (e.g., metadata) attributes as part of additional data (e.g., metadata tagging, for example, by including just the output-size in the metadata, just the CRC in metadata, both CRC and output-size in metadata, etc.).

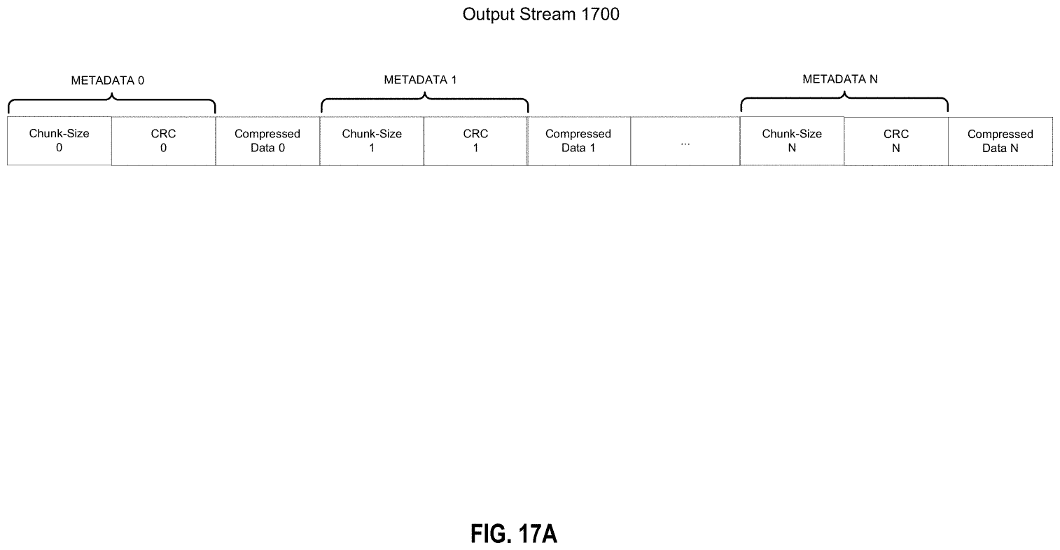

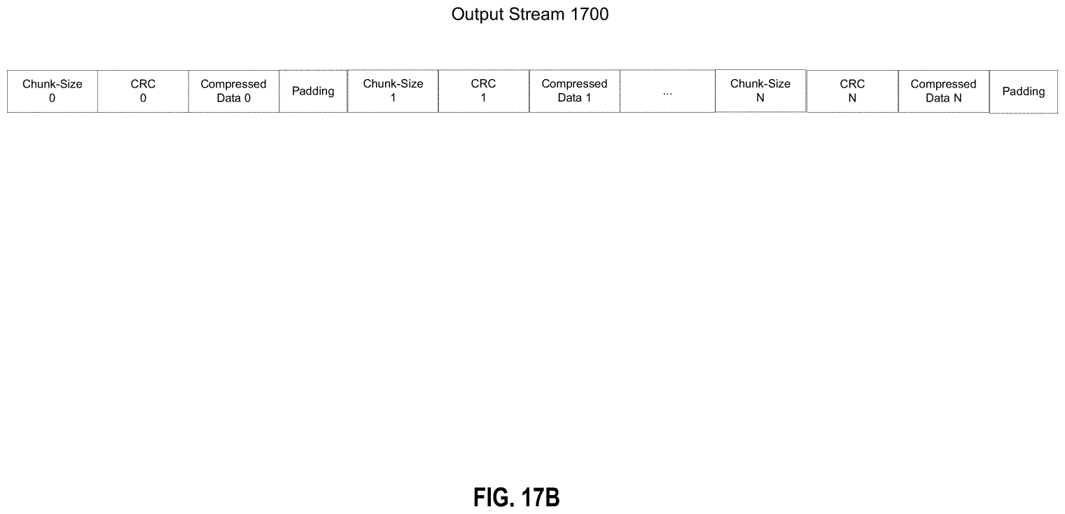

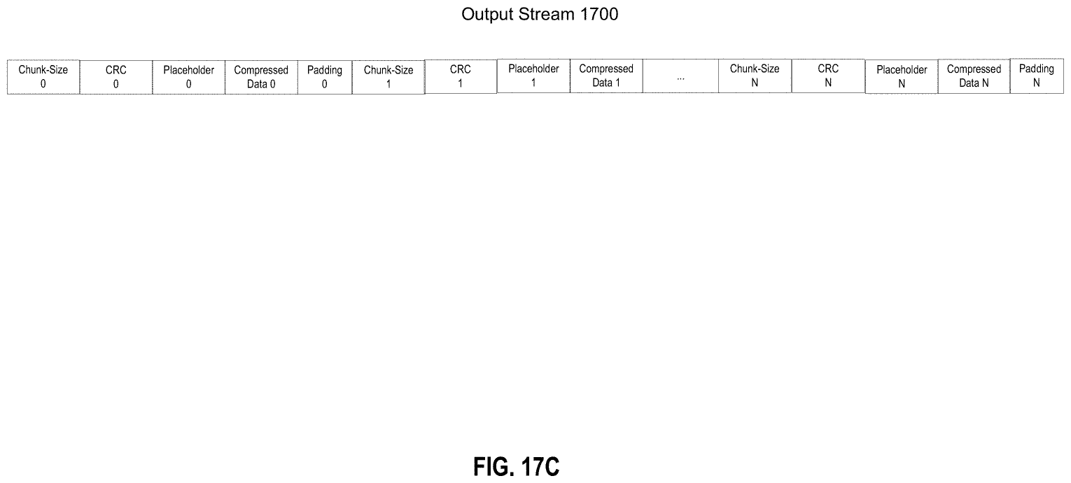

FIG. 17A illustrates an example format of an output stream 1700 of an accelerator that includes metadata according to examples of the disclosure. The depicted metadata in FIG. 17A includes the CRC and output (e.g., chunk) size in metadata for each corresponding subset of compressed data, although it should be understood that other metadata (or only one of the CRC or the output-size) are included in other examples.

Certain data-transformation operations generate output that is bit-aligned or not aligned to the usage requirements. In certain examples, an accelerator allows software to specify this functionality (e.g., alignment requirements) in the descriptor, e.g., by setting a corresponding flag. In certain examples, an accelerator (e.g., performing a compression operation) aligns its output to byte granularity (e.g., or 2/4/8/16-byte granularity) by adding padding instead of stopping at a partial bit position.

FIG. 17B illustrates an example format of an output stream 1700 of an accelerator that includes metadata and an additional “padding” value according to examples of the disclosure. Although output stream 1700 includes metadata (e.g., CRC and output (e.g., chunk) size in metadata), it should be understood that an output stream can have only one or any combination of those, e.g., just padding. The depicted padding in FIG. 17B includes padding for each corresponding subset of compressed data, although it should be understood that each subset may not require padding, e.g., when that compressed data is already aligned to a desired position.

Certain usages may have some additional software metadata for each chunk. In certain examples, it is useful to keep placeholder (e.g., holding) positions in output stream to allow (e.g., software) to quickly patch the stream with the additional data to avoid move/copy overheads to insert these metadata fields into an already created stream. For example, in live-migration usage it may be useful to tag a guest physical address (e.g., and other page attributes) along with the compressed data. In certain examples, an accelerator allows software to enable placeholder (e.g., holding) positions (e.g., along with specifying the size requirements for these placeholders) as indicated the descriptor, e.g., by setting a corresponding flag. In certain examples, hardware initializes these fields with a value of zero (e.g., 0x0).

FIG. 17C illustrates an example format of an output stream 1700 of an accelerator that includes metadata, an additional “padding” value, and an additional (e.g., pre-selected) “placeholder” value according to examples of the disclosure. Although output stream 1700 includes metadata (e.g., CRC and output (e.g., chunk) size in metadata) and padding, it should be understood that an output stream can have only one or any combination of those, e.g., just the placeholder. In certain examples, the placeholder is a pre-selected value, e.g., is the same value for each corresponding chunk (e.g., compressed data chunk in this example). In certain examples, an accelerator also stores index(es) (e.g., set of locations) for these placeholder locations (e.g., byte-offsets), for example, to allow software to later patch the placeholder values easily.

In certain examples, it is beneficial for software to provide value(s) for placeholder(s) and have hardware insert (e.g., patch) it as part of generating the output stream. In certain examples, an accelerator allows software to (i) specify this functionality in the descriptor, e.g., by setting a corresponding flag, and/or to (ii) specify the placeholder value(s) in the descriptor or provides an address from where these placeholder values can be fetched and inserted in the output stream.

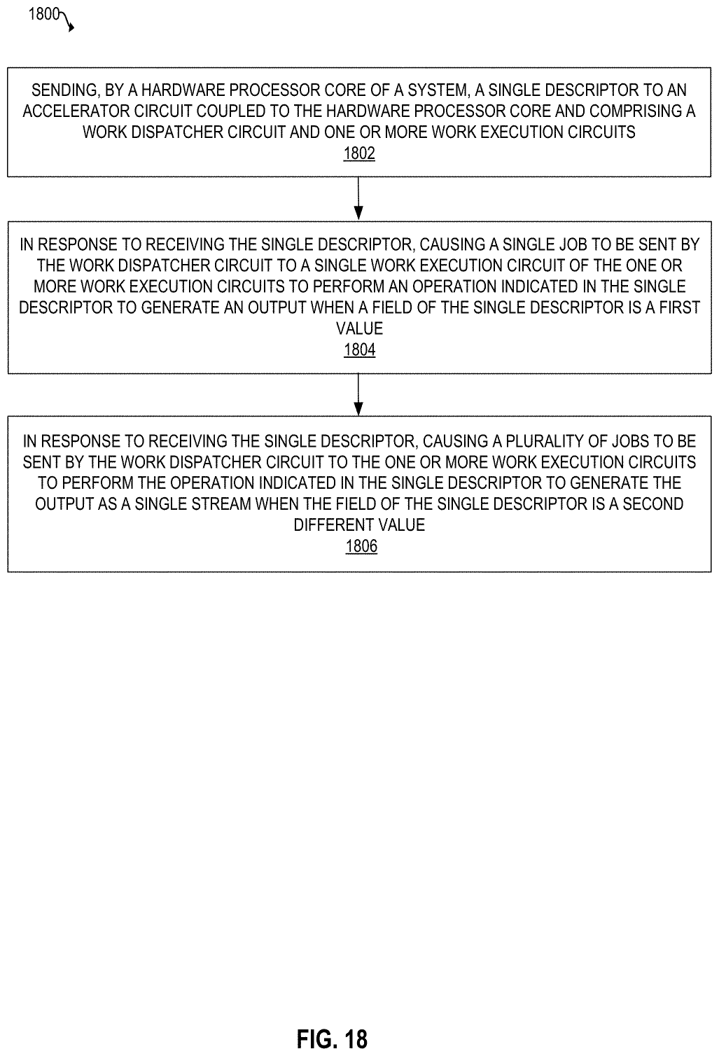

FIG. 18 is a flow diagram illustrating operations 1800 of a method of acceleration according to examples of the disclosure. Some or all of the operations 1800 (or other processes described herein, or variations, and/or combinations thereof) are performed under the control of a computer system (e.g., an accelerator thereof). The operations 1800 include, at block 1802, sending, by a hardware processor core of a system, a single descriptor to an accelerator circuit coupled to the hardware processor core and comprising a work dispatcher circuit and one or more work execution circuits. The operations 1800 further include, at block 1804, in response to receiving the single descriptor, causing a single job to be sent by the work dispatcher circuit to a single work execution circuit of the one or more work execution circuits to perform an operation indicated in the single descriptor to generate an output when a field of the single descriptor is a first value. The operations 1800 further include, at block 1806, in response to receiving the single descriptor, causing a plurality of jobs to be sent by the work dispatcher circuit to the one or more work execution circuits to perform the operation indicated in the single descriptor to generate the output as a single stream when the field of the single descriptor is a second different value.

Exemplary architectures, systems, etc. that the above may be used in are detailed below. Exemplary instruction formats that may cause enqueuing of a job for an accelerator are detailed below.

At least some examples of the disclosed technologies can be described in view of the following:
Example 1. An apparatus comprising:
a hardware processor core; and
an accelerator circuit coupled to the hardware processor core, the accelerator circuit comprising a work dispatcher circuit and one or more work execution circuits to, in response to a single descriptor sent from the hardware processor core:
   when a field of the single descriptor is a first value, cause a single job to be sent by the work dispatcher circuit to a single work execution circuit of the one or more work execution circuits to perform an operation indicated in the single descriptor to generate an output, and
   when the field of the single descriptor is a second different value, cause a plurality of jobs to be sent by the work dispatcher circuit to the one or more work execution circuits to perform the operation indicated in the single descriptor to generate the output as a single stream.
Example 2. The apparatus of example 1, wherein the single descriptor comprises a second field that when set to a first value indicates a transfer size field of the single descriptor indicates a number of bytes in an input for the operation, and when set to a second different value indicates the transfer size field of the single descriptor indicates a chunk size and a number of chunks in the input for the operation.
Example 3. The apparatus of example 2, wherein, when the second field is set to the second different value, the work dispatcher circuit is to cause the one or more work execution circuits to start the operation in response to receiving a first chunk of a plurality of chunks of the input.
Example 4. The apparatus of example 1, wherein the single descriptor comprises a second field that when set to a first value indicates a source address field or a destination address field of the single descriptor indicates a location of a single contiguous block of an input for the operation or the output, respectively, and when set to a second different value indicates the source address field or the destination address field of the single descriptor indicates a list of multiple non-contiguous locations of the input or the output, respectively.
Example 5. The apparatus of example 1, wherein, when the field of the single descriptor is the second different value, the work dispatcher circuit is to serialize the plurality of jobs by waiting to send a next job of the plurality of jobs to the one or more work execution circuits in response to an immediately previous job of the plurality of jobs being completed by the one or more work execution circuits.
Example 6. The apparatus of example 1, wherein, when the field of the single descriptor is the second different value, the work dispatcher circuit is to send the plurality of jobs in parallel to a plurality of work execution circuits.
Example 7. The apparatus of example 1, wherein, when the field of the single descriptor is the second different value and a metadata tagging field of the single descriptor is set, the accelerator circuit is to insert metadata into the single stream of output.
Example 8. The apparatus of example 1, wherein, when the field of the single descriptor is the second different value and an additional value field of the single descriptor is set, the accelerator circuit is to insert one or more additional values into the single stream of output.
Example 9. A method comprising:
sending, by a hardware processor core of a system, a single descriptor to an accelerator circuit coupled to the hardware processor core and comprising a work dispatcher circuit and one or more work execution circuits;
in response to receiving the single descriptor, causing a single job to be sent by the work dispatcher circuit to a single work execution circuit of the one or more work execution circuits to perform an operation indicated in the single descriptor to generate an output when a field of the single descriptor is a first value; and
in response to receiving the single descriptor, causing a plurality of jobs to be sent by the work dispatcher circuit to the one or more work execution circuits to perform the operation indicated in the single descriptor to generate the output as a single stream when the field of the single descriptor is a second different value.
Example 10. The method of example 9, wherein the single descriptor comprises a second field that when set to a first value indicates a transfer size field of the single descriptor indicates a number of bytes in an input for the operation, and when set to a second different value indicates the transfer size field of the single descriptor indicates a chunk size and a number of chunks in the input for the operation.
Example 11. The method of example 10, wherein, when the second field is set to the second different value, the work dispatcher circuit causes the one or more work execution circuits to start the operation in response to receiving a first chunk of a plurality of chunks of the input.
Example 12. The method of example 9, wherein the single descriptor comprises a second field that when set to a first value indicates a source address field or a destination address field of the single descriptor indicates a location of a single contiguous block of an input for the operation or the output, respectively, and when set to a second different value indicates the source address field or the destination address field of the single descriptor indicates a list of multiple non-contiguous locations of the input or the output, respectively.
Example 13. The method of example 9, wherein, when the field of the single descriptor is the second different value, the work dispatcher circuit serializes the plurality of jobs by waiting to send a next job of the plurality of jobs to the one or more work execution circuits in response to an immediately previous job of the plurality of jobs being completed by the one or more work execution circuits.
Example 14. The method of example 9, wherein, when the field of the single descriptor is the second different value, the work dispatcher circuit sends the plurality of jobs in parallel to a plurality of work execution circuits.
Example 15. The method of example 9, wherein, when the field of the single descriptor is the second different value and a metadata tagging field of the single descriptor is set, the accelerator circuit inserts metadata into the single stream of output.
Example 16. The method of example 9, wherein, when the field of the single descriptor is the second different value and an additional value field of the single descriptor is set, the accelerator circuit inserts one or more additional values into the single stream of output.
Example 17. An apparatus comprising:
a hardware processor core comprising:
   a decoder circuit to decode an instruction comprising an opcode into a decoded instruction, the opcode to indicate an execution circuit is to generate a single descriptor and cause the single descriptor to be sent to an accelerator circuit coupled to the hardware processor core, and
   the execution circuit to execute the decoded instruction according to the opcode; and
the accelerator circuit comprising a work dispatcher circuit and one or more work execution circuits to, in response to the single descriptor sent from the hardware processor core:
   when a field of the single descriptor is a first value, cause a single job to be sent by the work dispatcher circuit to a single work execution circuit of the one or more work execution circuits to perform an operation indicated in the single descriptor to generate an output, and
   when the field of the single descriptor is a second different value, cause a plurality of jobs to be sent by the work dispatcher circuit to the one or more work execution circuits to perform the operation indicated in the single descriptor to generate the output as a single stream.
Example 18. The apparatus of example 17, wherein the single descriptor comprises a second field that when set to a first value indicates a transfer size field of the single descriptor indicates a number of bytes in an input for the operation, and when set to a second different value indicates the transfer size field of the single descriptor indicates a chunk size and a number of chunks in the input for the operation.
Example 19. The apparatus of example 18, wherein, when the second field is set to the second different value, the work dispatcher circuit is to cause the one or more work execution circuits to start the operation in response to receiving a first chunk of a plurality of chunks of the input.
Example 20. The apparatus of example 17, wherein the single descriptor comprises a second field that when set to a first value indicates a source address field or a destination address field of the single descriptor indicates a location of a single contiguous block of an input for the operation or the output, respectively, and when set to a second different value indicates the source address field or the destination address field of the single descriptor indicates a list of multiple non-contiguous locations of the input or the output, respectively.
Example 21. The apparatus of example 17, wherein, when the field of the single descriptor is the second different value, the work dispatcher circuit is to serialize the plurality of jobs by waiting to send a next job of the plurality of jobs to the one or more work execution circuits in response to an immediately previous job of the plurality of jobs being completed by the one or more work execution circuits.
Example 22. The apparatus of example 17, wherein, when the field of the single descriptor is the second different value, the work dispatcher circuit is to send the plurality of jobs in parallel to a plurality of work execution circuits.
Example 23. The apparatus of example 17, wherein, when the field of the single descriptor is the second different value and a metadata tagging field of the single descriptor is set, the accelerator circuit is to insert metadata into the single stream of output.
Example 24. The apparatus of example 17, wherein, when the field of the single descriptor is the second different value and an additional value field of the single descriptor is set, the accelerator circuit is to insert one or more additional values into the single stream of output.

In yet another example, an apparatus comprises a data storage device that stores code that when executed by a hardware processor causes the hardware processor to perform any method disclosed herein. An apparatus may be as described in the detailed description. A method may be as described in the detailed description.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, November 2018; and see Intel® Architecture Instruction Set Extensions Programming Reference, October 2018).

### Exemplary Instruction Formats

Examples of the instruction(s) described herein may be embodied in different formats. Additionally, exemplary systems, architectures, and pipelines are detailed below. Examples of the instruction(s) may be executed on such systems, architectures, and pipelines, but are not limited to those detailed.

### Generic Vector Friendly Instruction Format

A vector friendly instruction format is an instruction format that is suited for vector instructions (e.g., there are certain fields specific to vector operations). While examples are described in which both vector and scalar operations are supported through the vector friendly instruction format, alternative examples use only vector operations the vector friendly instruction format.

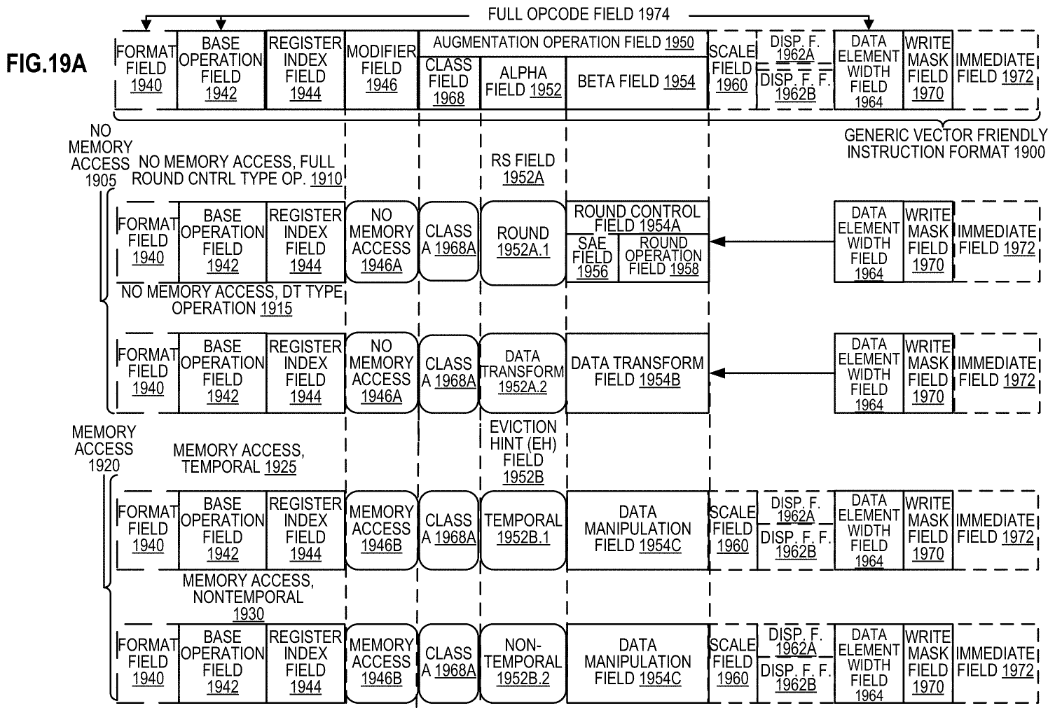

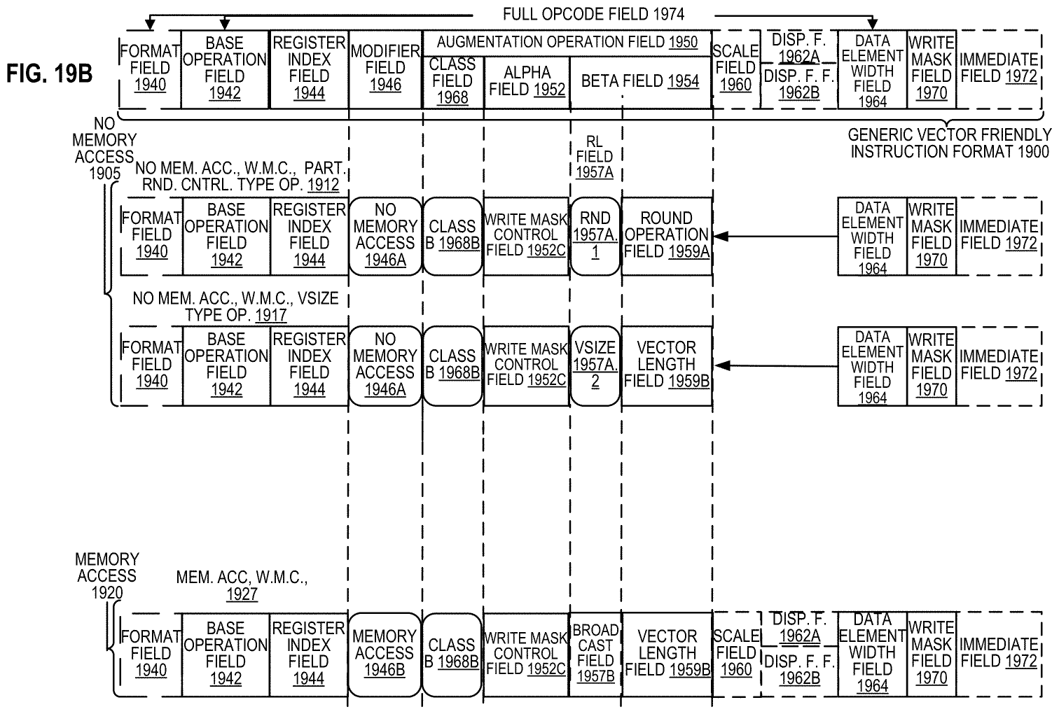

FIGS. 19A-19B are block diagrams illustrating a generic vector friendly instruction format and instruction templates thereof according to examples of the disclosure. FIG. 19A is a block diagram illustrating a generic vector friendly instruction format and class A instruction templates thereof according to examples of the disclosure; while FIG. 19B is a block diagram illustrating the generic vector friendly instruction format and class B instruction templates thereof according to examples of the disclosure. Specifically, a generic vector friendly instruction format 1900 for which are defined class A and class B instruction templates, both of which include no memory access 1905 instruction templates and memory access 1920 instruction templates. The term generic in the context of the vector friendly instruction format refers to the instruction format not being tied to any specific instruction set.

While examples of the disclosure will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative examples may support more, less and/or different vector operand sizes (e.g., 256 byte vector operands) with more, less, or different data element widths (e.g., 128 bit (16 byte) data element widths).

The class A instruction templates in FIG. 19A include: 1) within the no memory access 1905 instruction templates there is shown a no memory access, full round control type operation 1910 instruction template and a no memory access, data transform type operation 1915 instruction template; and 2) within the memory access 1920 instruction templates there is shown a memory access, temporal 1925 instruction template and a memory access, non-temporal 1930 instruction template. The class B instruction templates in FIG. 19B include: 1) within the no memory access 1905 instruction templates there is shown a no memory access, write mask control, partial round control type operation 1912 instruction template and a no memory access, write mask control, vsize type operation 1917 instruction template; and 2) within the memory access 1920 instruction templates there is shown a memory access, write mask control 1927 instruction template.

The generic vector friendly instruction format 1900 includes the following fields listed below in the order illustrated in FIGS. 19A-19B.

Format field 1940—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 1942—its content distinguishes different base operations.

Register index field 1944—its content, directly or through address generation, specifies the locations of the source and destination operands, be they in registers or in memory. These include a sufficient number of bits to select N registers from a PxQ (e.g., 32×512, 16×128, 32×1024, 64×1024) register file. While in one example N may be up to three sources and one destination register, alternative examples may support more or less sources and destination registers (e.g., may support up to two sources where one of these sources also acts as the destination, may support up to three sources where one of these sources also acts as the destination, may support up to two sources and one destination).

Modifier field 1946—its content distinguishes occurrences of instructions in the generic vector instruction format that specify memory access from those that do not; that is, between no memory access 1905 instruction templates and memory access 1920 instruction templates. Memory access operations read and/or write to the memory hierarchy (in some cases specifying the source and/or destination addresses using values in registers), while non-memory access operations do not (e.g., the source and destinations are registers). While in one example this field also selects between three different ways to perform memory address calculations, alternative examples may support more, less, or different ways to perform memory address calculations.

Augmentation operation field 1950—its content distinguishes which one of a variety of different operations to be performed in addition to the base operation. This field is context specific. In one example of the disclosure, this field is divided into a class field 1968, an alpha field 1952, and a beta field 1954. The augmentation operation field 1950 allows common groups of operations to be performed in a single instruction rather than 2, 3, or 4 instructions.

Scale field 1960—its content allows for the scaling of the index field's content for memory address generation (e.g., for address generation that uses 2^{scale}*index+base).

Displacement Field 1962A—its content is used as part of memory address generation (e.g., for address generation that uses 2^{scale}*index+base+displacement).

Displacement Factor Field 1962B (note that the juxtaposition of displacement field 1962A directly over displacement factor field 1962B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 1974 (described later herein) and the data manipulation field 1954C. The displacement field 1962A and the displacement factor field 1962B are optional in the sense that they are not used for the no memory access 1905 instruction templates and/or different examples may implement only one or none of the two.

Data element width field 1964—its content distinguishes which one of a number of data element widths is to be used (in some examples for all instructions; in other examples for only some of the instructions). This field is optional in the sense that it is not needed if only one data element width is supported and/or data element widths are supported using some aspect of the opcodes.

Write mask field 1970—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 1970 allows for partial vector operations, including loads, stores, arithmetic, logical, etc. While examples of the disclosure are described in which the write mask field's 1970 content selects one of a number of write mask registers that contains the write mask to be used (and thus the write mask field's 1970 content indirectly identifies that masking to be performed), alternative examples instead or additional allow the mask write field's 1970 content to directly specify the masking to be performed.

Immediate field 1972—its content allows for the specification of an immediate. This field is optional in the sense that is it not present in an implementation of the generic vector friendly format that does not support immediate and it is not present in instructions that do not use an immediate.

Class field 1968—its content distinguishes between different classes of instructions. With reference to FIGS. 19A-B, the contents of this field select between class A and class B instructions. In FIGS. 19A-B, rounded corner squares are used to indicate a specific value is present in a field (e.g., class A 1968A and class B 1968B for the class field 1968 respectively in FIGS. 19A-B).

### Instruction Templates of Class A

In the case of the non-memory access 1905 instruction templates of class A, the alpha field 1952 is interpreted as an RS field 1952A, whose content distinguishes which one of the different augmentation operation types are to be performed (e.g., round 1952A.1 and data transform 1952A.2 are respectively specified for the no memory access, round type operation 1910 and the no memory access, data transform type operation 1915 instruction templates), while the beta field 1954 distinguishes which of the operations of the specified type is to be performed. In the no memory access 1905 instruction templates, the scale field 1960, the displacement field 1962A, and the displacement scale filed 1962B are not present.

### No-Memory Access Instruction Templates—Full Round Control Type Operation

In the no memory access full round control type operation 1910 instruction template, the beta field 1954 is interpreted as a round control field 1954A, whose content(s) provide static rounding. While in the described examples of the disclosure the round control field 1954A includes a suppress all floating-point exceptions (SAE) field 1956 and a round operation control field 1958, alternative examples may support may encode both these concepts into the same field or only have one or the other of these concepts/fields (e.g., may have only the round operation control field 1958).

SAE field 1956—its content distinguishes whether or not to disable the exception event reporting; when the SAE field's 1956 content indicates suppression is enabled, a given instruction does not report any kind of floating-point exception flag and does not raise any floating-point exception handler.

Round operation control field 1958—its content distinguishes which one of a group of rounding operations to perform (e.g., Round-up, Round-down, Round-towards-zero and Round-to-nearest). Thus, the round operation control field 1958 allows for the changing of the rounding mode on a per instruction basis. In one example of the disclosure where a processor includes a control register for specifying rounding modes, the round operation control field's 1950 content overrides that register value.

### No Memory Access Instruction Templates—Data Transform Type Operation

In the no memory access data transform type operation 1915 instruction template, the beta field 1954 is interpreted as a data transform field 1954B, whose content distinguishes which one of a number of data transforms is to be performed (e.g., no data transform, swizzle, broadcast).

In the case of a memory access 1920 instruction template of class A, the alpha field 1952 is interpreted as an eviction hint field 1952B, whose content distinguishes which one of the eviction hints is to be used (in FIG. 19A, temporal 1952B.1 and non-temporal 1952B.2 are respectively specified for the memory access, temporal 1925 instruction template and the memory access, non-temporal 1930 instruction template), while the beta field 1954 is interpreted as a data manipulation field 1954C, whose content distinguishes which one of a number of data manipulation operations (also known as primitives) is to be performed (e.g., no manipulation; broadcast; up conversion of a source; and down conversion of a destination). The memory access 1920 instruction templates include the scale field 1960, and optionally the displacement field 1962A or the displacement scale field 1962B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

### Memory Access Instruction Templates—Temporal

Temporal data is data likely to be reused soon enough to benefit from caching. This is, however, a hint, and different processors may implement it in different ways, including ignoring the hint entirely.

### Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

Instruction Templates of Class B

In the case of the instruction templates of class B, the alpha field 1952 is interpreted as a write mask control (Z) field 1952C, whose content distinguishes whether the write masking controlled by the write mask field 1970 should be a merging or a zeroing.

In the case of the non-memory access 1905 instruction templates of class B, part of the beta field 1954 is interpreted as an RL field 1957A, whose content distinguishes which one of the different augmentation operation types are to be performed (e.g., round 1957A.1 and vector length (VSIZE) 1957A.2 are respectively specified for the no memory access, write mask control, partial round control type operation 1912 instruction template and the no memory access, write mask control, VSIZE type operation 1917 instruction template), while the rest of the beta field 1954 distinguishes which of the operations of the specified type is to be performed. In the no memory access 1905 instruction templates, the scale field 1960, the displacement field 1962A, and the displacement scale filed 1962B are not present.

In the no memory access, write mask control, partial round control type operation 1910 instruction template, the rest of the beta field 1954 is interpreted as a round operation field 1959A and exception event reporting is disabled (a given instruction does not report any kind of floating-point exception flag and does not raise any floating-point exception handler).

Round operation control field 1959A—just as round operation control field 1958, its content distinguishes which one of a group of rounding operations to perform (e.g., Round-up, Round-down, Round-towards-zero and Round-to-nearest). Thus, the round operation control field 1959A allows for the changing of the rounding mode on a per instruction basis. In one example of the disclosure where a processor includes a control register for specifying rounding modes, the round operation control field's 1950 content overrides that register value.

In the no memory access, write mask control, VSIZE type operation 1917 instruction template, the rest of the beta field 1954 is interpreted as a vector length field 1959B, whose content distinguishes which one of a number of data vector lengths is to be performed on (e.g., 128, 256, or 512 byte).

In the case of a memory access 1920 instruction template of class B, part of the beta field 1954 is interpreted as a broadcast field 1957B, whose content distinguishes whether or not the broadcast type data manipulation operation is to be performed, while the rest of the beta field 1954 is interpreted the vector length field 1959B. The memory access 1920 instruction templates include the scale field 1960, and optionally the displacement field 1962A or the displacement scale field 1962B.

With regard to the generic vector friendly instruction format 1900, a full opcode field 1974 is shown including the format field 1940, the base operation field 1942, and the data element width field 1964. While one example is shown where the full opcode field 1974 includes all of these fields, the full opcode field 1974 includes less than all of these fields in examples that do not support all of them. The full opcode field 1974 provides the operation code (opcode).

The augmentation operation field 1950, the data element width field 1964, and the write mask field 1970 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some examples of the disclosure, different processors or different cores within a processor may support only class A, only class B, or both classes. For instance, a high-performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the disclosure). Also, a single processor may include multiple cores, all of which support the same class or in which different cores support different class. For instance, in a processor with separate graphics and general-purpose cores, one of the graphics cores intended primarily for graphics and/or scientific computing may support only class A, while one or more of the general-purpose cores may be high-performance general-purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different examples of the disclosure. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

### Exemplary Specific Vector Friendly Instruction Format

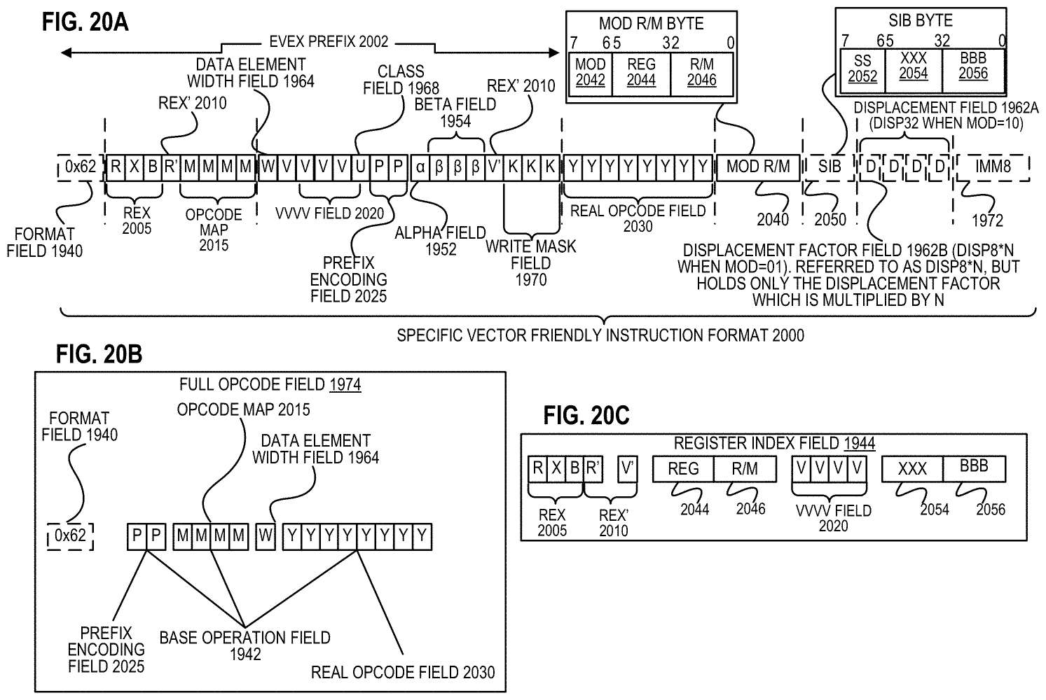

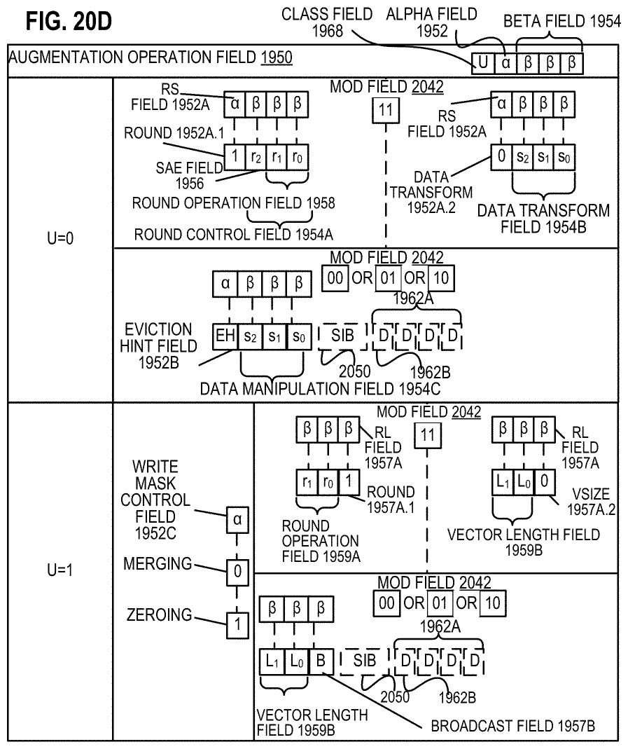

FIG. 20 is a block diagram illustrating an exemplary specific vector friendly instruction format according to examples of the disclosure. FIG. 20 shows a specific vector friendly instruction format 2000 that is specific in the sense that it specifies the location, size, interpretation, and order of the fields, as well as values for some of those fields. The specific vector friendly instruction format 2000 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 19 into which the fields from FIG. 20 map are illustrated.

It should be understood that, although examples of the disclosure are described with reference to the specific vector friendly instruction format 2000 in the context of the generic vector friendly instruction format 1900 for illustrative purposes, the disclosure is not limited to the specific vector friendly instruction format 2000 except where claimed. For example, the generic vector friendly instruction format 1900 contemplates a variety of possible sizes for the various fields, while the specific vector friendly instruction format 2000 is shown as having fields of specific sizes. By way of specific example, while the data element width field 1964 is illustrated as a one bit field in the specific vector friendly instruction format 2000, the disclosure is not so limited (that is, the generic vector friendly instruction format 1900 contemplates other sizes of the data element width field 1964).

The generic vector friendly instruction format 1900 includes the following fields listed below in the order illustrated in FIG. 20A.

EVEX Prefix (Bytes 0-3) 2002—is encoded in a four-byte form.

Format Field 1940 (EVEX Byte 0, bits [7:0])—the first byte (EVEX Byte 0) is the format field 1940 and it contains 0x62 (the unique value used for distinguishing the vector friendly instruction format in one example of the disclosure).

The second-fourth bytes (EVEX Bytes 1-3) include a number of bit fields providing specific capability.

REX field 2005 (EVEX Byte 1, bits [7-5])—consists of a EVEX.R bit field (EVEX Byte 1, bit [7]-R), EVEX.X bit field (EVEX byte 1, bit [6]-X), and 1957 BEX byte 1, bit[5]-B). The EVEX.R, EVEX.X, and EVEX.B bit fields provide the same functionality as the corresponding VEX bit fields, and are encoded using 1s complement form, e.g., ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 1910—this is the first part of the REX′ field 1910 and is the EVEX.R′ bit field (EVEX Byte 1, bit [4]-R′) that is used to encode either the upper 16 or lower 16 of the extended 32 register set. In one example of the disclosure, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative examples of the disclosure do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 2015 (EVEX byte 1, bits [3:0]-mmmm)—its content encodes an implied leading opcode byte (0F, 0F 38, or 0F 3).

Data element width field 1964 (EVEX byte 2, bit [7]-W)—is represented by the notation EVEX.W. EVEX.W is used to define the granularity (size) of the datatype (either 32-bit data elements or 64-bit data elements).

EVEX.vvvv 2020 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in is complement form for certain vector shifts; or 3) EVEX.vvvv does not encode any operand, the field is reserved and should contain 1111b. Thus, EVEX.vvvv field 2020 encodes the 4 low-order bits of the first source register specifier stored in inverted (1s complement) form. Depending on the instruction, an extra different EVEX bit field is used to extend the specifier size to 32 registers.

EVEX.U 1968 Class field (EVEX byte 2, bit [2]-U)—If EVEX.0=0, it indicates class A or EVEX.U0; if EVEX.0=1, it indicates class B or EVEX.U1.

Prefix encoding field 2025 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one example, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain examples expand in a similar fashion for consistency but allow for different meanings to be specified by these legacy SIMD prefixes. An alternative example may redesign the PLA to support the 2-bit SIMD prefix encodings, and thus not require the expansion.

Alpha field 1952 (EVEX byte 3, bit [7]-EH; also known as EVEX.EH, EVEX.rs, EVEX.RL, EVEX.write mask control, and EVEX.N; also illustrated with α)—as previously described, this field is context specific.

Beta field 1954 (EVEX byte 3, bits [6:4]-SSS, also known as EVEX.s₂₋₀, EVEX.r₂₋₀, EVEX.rr1, EVEX.LL0, EVEX.LLB; also illustrated with βββ)—as previously described, this field is context specific.

REX′ field 1910—this is the remainder of the REX′ field and is the EVEX.V′ bit field (EVEX Byte 3, bit [3]-V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 1970 (EVEX byte 3, bits [2:0]-kkk)—its content specifies the index of a register in the write mask registers as previously described. In one example of the disclosure, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 2030 (Byte 4) is also known as the opcode byte. Part of the opcode is specified in this field.

MOD R/M Field 2040 (Byte 5) includes MOD field 2042, Reg field 2044, and R/M field 2046. As previously described, the MOD field's 2042 content distinguishes between memory access and non-memory access operations. The role of Reg field 2044 can be summarized to two situations: encoding either the destination register operand or a source register operand, or be treated as an opcode extension and not used to encode any instruction operand. The role of R/M field 2046 may include the following: encoding the instruction operand that references a memory address, or encoding either the destination register operand or a source register operand.

Scale, Index, Base (SIB) Byte (Byte 6)—As previously described, the scale field's 1950 content is used for memory address generation. SIB.xxx 2054 and SIB.bbb 2056—the contents of these fields have been previously referred to with regard to the register indexes Xxxx and Bbbb.

Displacement field 1962A (Bytes 7-10)—when MOD field 2042 contains 10, bytes 7-10 are the displacement field 1962A, and it works the same as the legacy 32-bit displacement (disp32) and works at byte granularity.

Displacement factor field 1962B (Byte 7)—when MOD field 2042 contains 01, byte 7 is the displacement factor field 1962B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 1962B is a reinterpretation of disp8; when using displacement factor field 1962B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 1962B substitutes the legacy x86 instruction set 8-bit displacement. Thus, the displacement factor field 1962B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset). Immediate field 1972 operates as previously described.

### Full Opcode Field

FIG. 20B is a block diagram illustrating the fields of the specific vector friendly instruction format 2000 that make up the full opcode field 1974 according to one example of the disclosure. Specifically, the full opcode field 1974 includes the format field 1940, the base operation field 1942, and the data element width (W) field 1964. The base operation field 1942 includes the prefix encoding field 2025, the opcode map field 2015, and the real opcode field 2030.

### Register Index Field

FIG. 20C is a block diagram illustrating the fields of the specific vector friendly instruction format 2000 that make up the register index field 1944 according to one example of the disclosure. Specifically, the register index field 1944 includes the REX field 2005, the REX′ field 2010, the MODR/M.reg field 2044, the MODR/M.r/m field 2046, the VVVV field 2020, xxx field 2054, and the bbb field 2056.

### Augmentation Operation Field

FIG. 20D is a block diagram illustrating the fields of the specific vector friendly instruction format 2000 that make up the augmentation operation field 1950 according to one example of the disclosure. When the class (U) field 1968 contains 0, it signifies EVEX.U0 (class A 1968A); when it contains 1, it signifies EVEX.U1 (class B 1968B). When U=0 and the MOD field 2042 contains 11 (signifying a no memory access operation), the alpha field 1952 (EVEX byte 3, bit [7]-EH) is interpreted as the rs field 1952A. When the rs field 1952A contains a 1 (round 1952A.1), the beta field 1954 (EVEX byte 3, bits [6:4]-SSS) is interpreted as the round control field 1954A. The round control field 1954A includes a one bit SAE field 1956 and a two bit round operation field 1958. When the rs field 1952A contains a 0 (data transform 1952A.2), the beta field 1954 (EVEX byte 3, bits [6:4]-SSS) is interpreted as a three bit data transform field 1954B. When U=0 and the MOD field 2042 contains 00, 01, or 10 (signifying a memory access operation), the alpha field 1952 (EVEX byte 3, bit [7]-EH) is interpreted as the eviction hint (EH) field 1952B and the beta field 1954 (EVEX byte 3, bits [6:4]-SSS) is interpreted as a three bit data manipulation field 1954C.

When U=1, the alpha field 1952 (EVEX byte 3, bit [7]-EH) is interpreted as the write mask control (Z) field 1952C. When U=1 and the MOD field 2042 contains 11 (signifying a no memory access operation), part of the beta field 1954 (EVEX byte 3, bit [4]-S₀) is interpreted as the RL field 1957A; when it contains a 1 (round 1957A.1) the rest of the beta field 1954 (EVEX byte 3, bit [6-5]-S₂₋₁) is interpreted as the round operation field 1959A, while when the RL field 1957A contains a 0 (VSIZE 1957.A2) the rest of the beta field 1954 (EVEX byte 3, bit [6-5]-S₂₋₁) is interpreted as the vector length field 1959B (EVEX byte 3, bit [6-5]-L₁₋₀). When U=1 and the MOD field 2042 contains 00, 01, or 10 (signifying a memory access operation), the beta field 1954 (EVEX byte 3, bits [6:4]-SSS) is interpreted as the vector length field 1959B (EVEX byte 3, bit [6-5]-L₁₋₀) and the broadcast field 1957B (EVEX byte 3, bit [4]-B).

### Exemplary Register Architecture

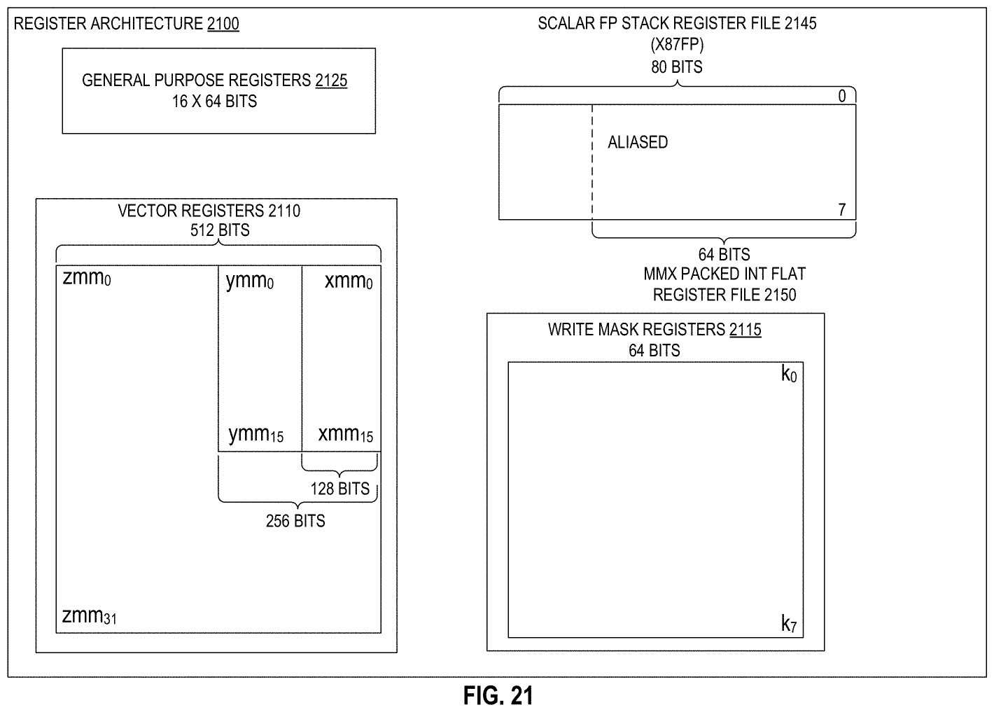

FIG. 21 is a block diagram of a register architecture 2100 according to one example of the disclosure. In the example illustrated, there are 32 vector registers 2110 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 2000 operates on these overlaid register file as illustrated in the below tables.

| Adjustable Vector Length | Class | Operations | Registers |
|---|---|---|---|
| Instruction Templates that | A (Figure 19A; | 1910, 1915, | zmm registers (the vector length |
| length field 1959B | U = 0) | 1925, 1930 | is 64 byte) |
| do not include the vector | B (Figure 19B; | 1912 | zmm registers (the vector length |
| | U = 1) | | is 64 byte) |
| Instruction templates that | B (Figure 19B; | 1917, 1927 | zmm, ymm, or xmm registers |
| do include the vector | U = 1) | | (the vector length is 64 byte, 32 |
| length field 1959B | | | byte, or 16 byte) depending on |
| | | | the vector length field 1959B |

In other words, the vector length field 1959B selects between a maximum length and one or more other shorter lengths, where each such shorter length is half the length of the preceding length; and instructions templates without the vector length field 1959B operate on the maximum vector length. Further, in one example, the class B instruction templates of the specific vector friendly instruction format 2000 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the example.

Write mask registers 2115—in the example illustrated, there are 8 write mask registers (k0 through k7), each 64 bits in size. In an alternate example, the write mask registers 2115 are 16 bits in size. As previously described, in one example of the disclosure, the vector mask register k0 cannot be used as a write mask; when the encoding that would normally indicate k0 is used for a write mask, it selects a hardwired write mask of 0xFFFF, effectively disabling write masking for that instruction.

General-purpose registers 2125—in the example illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 2145, on which is aliased the MMX packed integer flat register file 2150—in the example illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative examples of the disclosure may use wider or narrower registers. Additionally, alternative examples of the disclosure may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

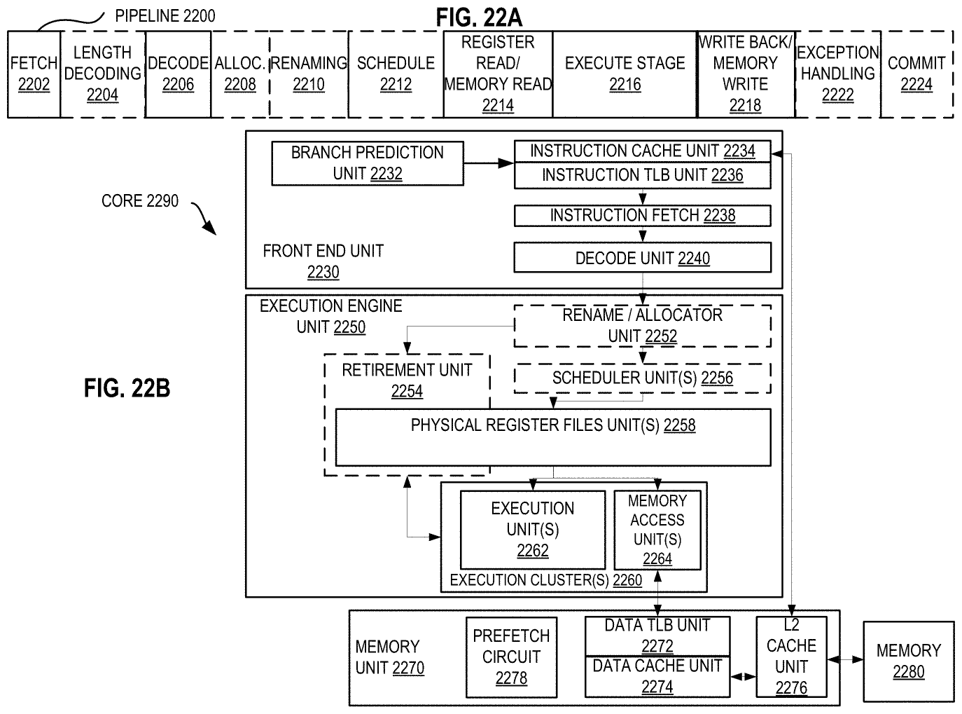

FIG. 22A is a block diagram illustrating both an exemplary in-order pipeline and an exemplary register renaming, out-of-order issue/execution pipeline according to examples of the disclosure. FIG. 22B is a block diagram illustrating both an exemplary example of an in-order architecture core and an exemplary register renaming, out-of-order issue/execution architecture core to be included in a processor according to examples of the disclosure. The solid lined boxes in FIGS. 22A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 22A, a processor pipeline 2200 includes a fetch stage 2202, a length decode stage 2204, a decode stage 2206, an allocation stage 2208, a renaming stage 2210, a scheduling (also known as a dispatch or issue) stage 2212, a register read/memory read stage 2214, an execute stage 2216, a write back/memory write stage 2218, an exception handling stage 2222, and a commit stage 2224.

FIG. 22B shows processor core 2290 including a front-end unit 2230 coupled to an execution engine unit 2250, and both are coupled to a memory unit 2270. The core 2290 may be a reduced instruction set computing (RISC) core, a complex instruction set computing (CISC) core, a very long instruction word (VLIW) core, or a hybrid or alternative core type. As yet another option, the core 2290 may be a special-purpose core, such as, for example, a network or communication core, compression engine, coprocessor core, general purpose computing graphics processing unit (GPGPU) core, graphics core, or the like.

The front-end unit 2230 includes a branch prediction unit 2232 coupled to an instruction cache unit 2234, which is coupled to an instruction translation lookaside buffer (TLB) 2236, which is coupled to an instruction fetch unit 2238, which is coupled to a decode unit 2240. The decode unit 2240 (or decoder or decoder unit) may decode instructions (e.g., macro-instructions), and generate as an output one or more micro-operations, micro-code entry points, micro-instructions, other instructions, or other control signals, which are decoded from, or which otherwise reflect, or are derived from, the original instructions. The decode unit 2240 may be implemented using various different mechanisms. Examples of suitable mechanisms include, but are not limited to, look-up tables, hardware implementations, programmable logic arrays (PLAs), microcode read only memories (ROMs), etc. In one example, the core 2290 includes a microcode ROM or other medium that stores microcode for certain macro-instructions (e.g., in decode unit 2240 or otherwise within the front-end unit 2230). The decode unit 2240 is coupled to a rename/allocator unit 2252 in the execution engine unit 2250.

The execution engine unit 2250 includes the rename/allocator unit 2252 coupled to a retirement unit 2254 and a set of one or more scheduler unit(s) 2256. The scheduler unit(s) 2256 represents any number of different schedulers, including reservations stations, central instruction window, etc. The scheduler unit(s) 2256 is coupled to the physical register file(s) unit(s) 2258. Each of the physical register file(s) units 2258 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one example, the physical register file(s) unit 2258 comprises a vector registers unit, a write mask registers unit, and a scalar registers unit. These register units may provide architectural vector registers, vector mask registers, and general-purpose registers. The physical register file(s) unit(s) 2258 is overlapped by the retirement unit 2254 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 2254 and the physical register file(s) unit(s) 2258 are coupled to the execution cluster(s) 2260. The execution cluster(s) 2260 includes a set of one or more execution units 2262 and a set of one or more memory access units 2264. The execution units 2262 may perform various operations (e.g., shifts, addition, subtraction, multiplication) and on various types of data (e.g., scalar floating point, packed integer, packed floating point, vector integer, vector floating point). While some examples may include a number of execution units dedicated to specific functions or sets of functions, other examples may include only one execution unit or multiple execution units that all perform all functions. The scheduler unit(s) 2256, physical register file(s) unit(s) 2258, and execution cluster(s) 2260 are shown as being possibly plural because certain examples create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain examples are implemented in which only the execution cluster of this pipeline has the memory access unit(s) 2264). It should also be understood that where separate pipelines are used, one or more of these pipelines may be out-of-order issue/execution and the rest in-order.

The set of memory access units 2264 is coupled to the memory unit 2270, which includes a data TLB unit 2272 coupled to a data cache unit 2274 coupled to a level 2 (L2) cache unit 2276. In one exemplary example, the memory access units 2264 may include a load unit, a store address unit, and a store data unit, each of which is coupled to the data TLB unit 2272 in the memory unit 2270. The instruction cache unit 2234 is further coupled to a level 2 (L2) cache unit 2276 in the memory unit 2270. The L2 cache unit 2276 is coupled to one or more other levels of cache and eventually to a main memory.

In certain examples, a prefetch circuit 2278 is included to prefetch data, for example, to predict access addresses and bring the data for those addresses into a cache or caches (e.g., from memory 2280).

By way of example, the exemplary register renaming, out-of-order issue/execution core architecture may implement the pipeline 2200 as follows: 1) the instruction fetch 2238 performs the fetch and length decoding stages 2202 and 2204; 2) the decode unit 2240 performs the decode stage 2206; 3) the rename/allocator unit 2252 performs the allocation stage 2208 and renaming stage 2210; 4) the scheduler unit(s) 2256 performs the schedule stage 2212; 5) the physical register file(s) unit(s) 2258 and the memory unit 2270 perform the register read/memory read stage 2214; the execution cluster 2260 perform the execute stage 2216; 6) the memory unit 2270 and the physical register file(s) unit(s) 2258 perform the write back/memory write stage 2218; 7) various units may be involved in the exception handling stage 2222; and 8) the retirement unit 2254 and the physical register file(s) unit(s) 2258 perform the commit stage 2224.

The core 2290 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one example, the core 2290 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyper-Threading technology).

While register renaming is described in the context of out-of-order execution, it should be understood that register renaming may be used in an in-order architecture. While the illustrated example of the processor also includes separate instruction and data cache units 2234/2274 and a shared L2 cache unit 2276, alternative examples may have a single internal cache for both instructions and data, such as, for example, a Level 1 (L1) internal cache, or multiple levels of internal cache. In some examples, the system may include a combination of an internal cache and an external cache that is external to the core and/or the processor. Alternatively, all of the cache may be external to the core and/or the processor.

### Specific Exemplary In-Order Core Architecture

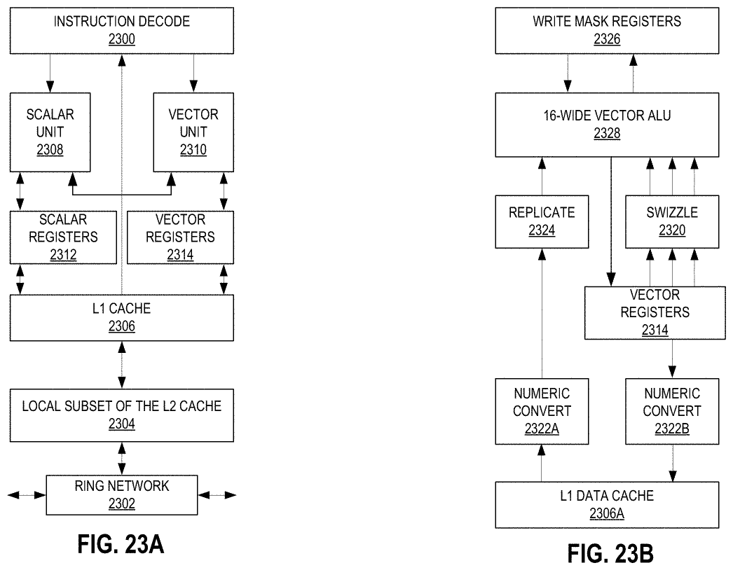

FIGS. 23A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 23A is a block diagram of a single processor core, along with its connection to the on-die interconnect network 2302 and with its local subset of the Level 2 (L2) cache 2304, according to examples of the disclosure. In one example, an instruction decode unit 2300 supports the x86 instruction set with a packed data instruction set extension. An L1 cache 2306 allows low-latency accesses to cache memory into the scalar and vector units. While in one example (to simplify the design), a scalar unit 2308 and a vector unit 2310 use separate register sets (respectively, scalar registers 2312 and vector registers 2314) and data transferred between them is written to memory and then read back in from a level 1 (L1) cache 2306, alternative examples of the disclosure may use a different approach (e.g., use a single register set or include a communication path that allow data to be transferred between the two register files without being written and read back).

The local subset of the L2 cache 2304 is part of a global L2 cache that is divided into separate local subsets, one per processor core. Each processor core has a direct access path to its own local subset of the L2 cache 2304. Data read by a processor core is stored in its L2 cache subset 2304 and can be accessed quickly, in parallel with other processor cores accessing their own local L2 cache subsets. Data written by a processor core is stored in its own L2 cache subset 2304 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 23B is an expanded view of part of the processor core in FIG. 23A according to examples of the disclosure. FIG. 23B includes an L1 data cache 2306A part of the L1 cache 2304, as well as more detail regarding the vector unit 2310 and the vector registers 2314. Specifically, the vector unit 2310 is a 16-wide vector processing unit (VPU) (see the 16-wide ALU 2328), which executes one or more of integer, single-precision float, and double-precision float instructions. The VPU supports swizzling the register inputs with swizzle unit 2320, numeric conversion with numeric convert units 2322A-B, and replication with replication unit 2324 on the memory input. Write mask registers 2326 allow predicating resulting vector writes.

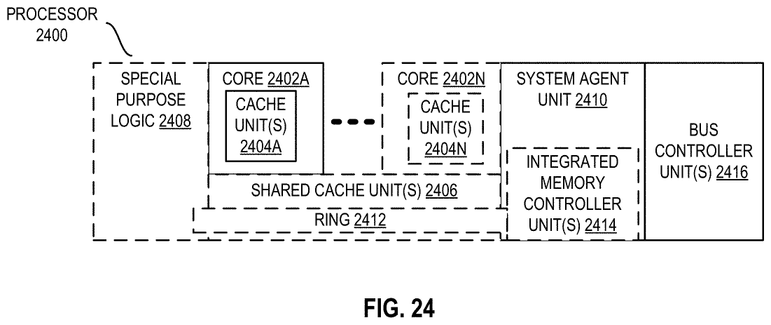

FIG. 24 is a block diagram of a processor 2400 that may have more than one core, may have an integrated memory controller, and may have integrated graphics according to examples of the disclosure. The solid lined boxes in FIG. 24 illustrate a processor 2400 with a single core 2402A, a system agent 2410, a set of one or more bus controller units 2416, while the optional addition of the dashed lined boxes illustrates an alternative processor 2400 with multiple cores 2402A-N, a set of one or more integrated memory controller unit(s) 2414 in the system agent unit 2410, and special purpose logic 2408.

Thus, different implementations of the processor 2400 may include: 1) a CPU with the special purpose logic 2408 being integrated graphics and/or scientific (throughput) logic (which may include one or more cores), and the cores 2402A-N being one or more general purpose cores (e.g., general purpose in-order cores, general purpose out-of-order cores, a combination of the two); 2) a coprocessor with the cores 2402A-N being a large number of special purpose cores intended primarily for graphics and/or scientific (throughput); and 3) a coprocessor with the cores 2402A-N being a large number of general purpose in-order cores. Thus, the processor 2400 may be a general-purpose processor, coprocessor, or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 2400 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 2406, and external memory (not shown) coupled to the set of integrated memory controller units 2414. The set of shared cache units 2406 may include one or more mid-level caches, such as level 2 (L2), level 3 (L3), level 4 (L4), or other levels of cache, a last level cache (LLC), and/or combinations thereof. While in one example a ring-based interconnect unit 2412 interconnects the integrated graphics logic 2408, the set of shared cache units 2406, and the system agent unit 2410/integrated memory controller unit(s) 2414, alternative examples may use any number of well-known techniques for interconnecting such units. In one example, coherency is maintained between one or more cache units 2406 and cores 2402-A-N.

In some examples, one or more of the cores 2402A-N are capable of multi-threading. The system agent 2410 includes those components coordinating and operating cores 2402A-N. The system agent unit 2410 may include for example a power control unit (PCU) and a display unit. The PCU may be or include logic and components needed for regulating the power state of the cores 2402A-N and the integrated graphics logic 2408. The display unit is for driving one or more externally connected displays.

The cores 2402A-N may be homogenous or heterogeneous in terms of architecture instruction set; that is, two or more of the cores 2402A-N may be capable of execution the same instruction set, while others may be capable of executing only a subset of that instruction set or a different instruction set.

### Exemplary Computer Architectures

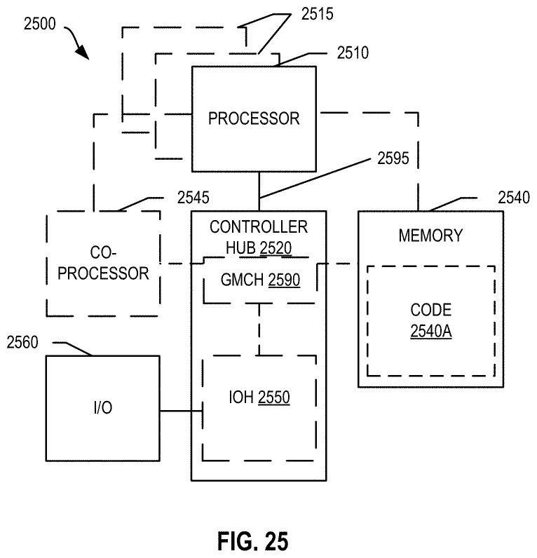

FIGS. 25-28 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a huge variety of systems or electronic devices capable of incorporating a processor and/or other execution logic as disclosed herein are generally suitable.

Referring now to FIG. 25, shown is a block diagram of a system 2500 in accordance with one example of the present disclosure. The system 2500 may include one or more processors 2510, 2515, which are coupled to a controller hub 2520. In one example the controller hub 2520 includes a graphics memory controller hub (GMCH) 2590 and an Input/Output Hub (IOH) 2550 (which may be on separate chips); the GMCH 2590 includes memory and graphics controllers to which are coupled memory 2540 and a coprocessor 2545; the IOH 2550 is couples input/output (I/O) devices 2560 to the GMCH 2590. Alternatively, one or both of the memory and graphics controllers are integrated within the processor (as described herein), the memory 2540 and the coprocessor 2545 are coupled directly to the processor 2510, and the controller hub 2520 in a single chip with the IOH 2550. Memory 2540 may include code 2540A, for example, to store code that when executed causes a processor to perform any method of this disclosure.

The optional nature of additional processors 2515 is denoted in FIG. 25 with broken lines. Each processor 2510, 2515 may include one or more of the processing cores described herein and may be some version of the processor 2400.

The memory 2540 may be, for example, dynamic random-access memory (DRAM), phase change memory (PCM), or a combination of the two. For at least one example, the controller hub 2520 communicates with the processor(s) 2510, 2515 via a multi-drop bus, such as a frontside bus (FSB), point-to-point interface such as Quickpath Interconnect (QPI), or similar connection 2595.

In one example, the coprocessor 2545 is a special-purpose processor, such as, for example, a high-throughput MIC processor, a network or communication processor, compression engine, graphics processor, GPGPU, embedded processor, or the like. In one example, controller hub 2520 may include an integrated graphics accelerator.

There can be a variety of differences between the physical resources 2510, 2515 in terms of a spectrum of metrics of merit including architectural, microarchitectural, thermal, power consumption characteristics, and the like.

In one example, the processor 2510 executes instructions that control data processing operations of a general type. Embedded within the instructions may be coprocessor instructions. The processor 2510 recognizes these coprocessor instructions as being of a type that should be executed by the attached coprocessor 2545. Accordingly, the processor 2510 issues these coprocessor instructions (or control signals representing coprocessor instructions) on a coprocessor bus or other interconnect, to coprocessor 2545. Coprocessor(s) 2545 accept and execute the received coprocessor instructions.

Referring now to FIG. 26, shown is a block diagram of a first more specific exemplary system 2600 in accordance with an example of the present disclosure. As shown in FIG. 26, multiprocessor system 2600 is a point-to-point interconnect system, and includes a first processor 2670 and a second processor 2680 coupled via a point-to-point interconnect 2650. Each of processors 2670 and 2680 may be some version of the processor 2400. In one example of the disclosure, processors 2670 and 2680 are respectively processors 2510 and 2515, while coprocessor 2638 is coprocessor 2545. In another example, processors 2670 and 2680 are respectively processor 2510 coprocessor 2545.

Processors 2670 and 2680 are shown including integrated memory controller (IMC) units 2672 and 2682, respectively. Processor 2670 also includes as part of its bus controller units point-to-point (P-P) interfaces 2676 and 2678; similarly, second processor 2680 includes P-P interfaces 2686 and 2688. Processors 2670, 2680 may exchange information via a point-to-point (P-P) interface 2650 using P-P interface circuits 2678, 2688. As shown in FIG. 26, IMCs 2672 and 2682 couple the processors to respective memories, namely a memory 2632 and a memory 2634, which may be portions of main memory locally attached to the respective processors.

Processors 2670, 2680 may each exchange information with a chipset 2690 via individual P-P interfaces 2652, 2654 using point to point interface circuits 2676, 2694, 2686, 2698. Chipset 2690 may optionally exchange information with the coprocessor 2638 via a high-performance interface 2639. In one example, the coprocessor 2638 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 2690 may be coupled to a first bus 2616 via an interface 2696. In one example, first bus 2616 may be a Peripheral Component Interconnect (PCI) bus, or a bus such as a PCI Express bus or another third generation I/O interconnect bus, although the scope of the present disclosure is not so limited.

As shown in FIG. 26, various I/O devices 2614 may be coupled to first bus 2616, along with a bus bridge 2618 which couples first bus 2616 to a second bus 2620. In one example, one or more additional processor(s) 2615, such as coprocessors, high-throughput MIC processors, GPGPU's, accelerators (such as, e.g., graphics accelerators or digital signal processing (DSP) units), field programmable gate arrays, or any other processor, are coupled to first bus 2616. In one example, second bus 2620 may be a low pin count (LPC) bus. Various devices may be coupled to a second bus 2620 including, for example, a keyboard and/or mouse 2622, communication devices 2627 and a storage unit 2628 such as a disk drive or other mass storage device which may include instructions/code and data 2630, in one example. Further, an audio I/O 2624 may be coupled to the second bus 2620. Note that other architectures are possible. For example, instead of the point-to-point architecture of FIG. 26, a system may implement a multi-drop bus or other such architecture.

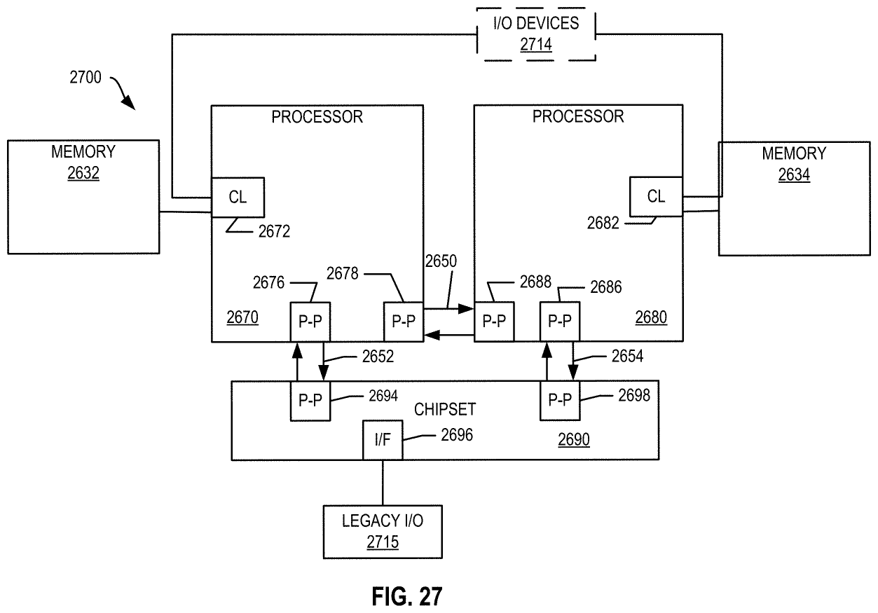

Referring now to FIG. 27, shown is a block diagram of a second more specific exemplary system 2700 in accordance with an example of the present disclosure. Like elements in FIGS. 26 and 27 bear like reference numerals, and certain aspects of FIG. 26 have been omitted from FIG. 27 in order to avoid obscuring other aspects of FIG. 27.

FIG. 27 illustrates that the processors 2670, 2680 may include integrated memory and I/O control logic (“CL”) 2672 and 2682, respectively. Thus, the CL 2672, 2682 include integrated memory controller units and include I/O control logic. FIG. 27 illustrates that not only are the memories 2632, 2634 coupled to the CL 2672, 2682, but also that I/O devices 2714 are also coupled to the control logic 2672, 2682. Legacy I/O devices 2715 are coupled to the chipset 2690.

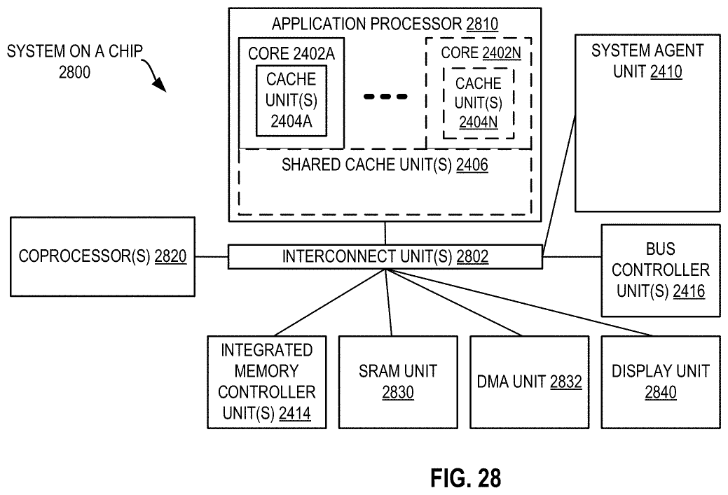

Referring now to FIG. 28, shown is a block diagram of a SoC 2800 in accordance with an example of the present disclosure. Similar elements in FIG. 24 bear like reference numerals. Also, dashed lined boxes are optional features on more advanced SoCs. In FIG. 28, an interconnect unit(s) 2802 is coupled to: an application processor 2810 which includes a set of one or more cores 2402A-N and shared cache unit(s) 2406; a system agent unit 2410; a bus controller unit(s) 2416; an integrated memory controller unit(s) 2414; a set or one or more coprocessors 2820 which may include integrated graphics logic, an image processor, an audio processor, and a video processor; an static random access memory (SRAM) unit 2830; a direct memory access (DMA) unit 2832; and a display unit 2840 for coupling to one or more external displays. In one example, the coprocessor(s) 2820 include a special-purpose processor, such as, for example, a network or communication processor, compression engine, GPGPU, a high-throughput MIC processor, embedded processor, or the like.

Examples (e.g., of the mechanisms) disclosed herein may be implemented in hardware, software, firmware, or a combination of such implementation approaches. Examples of the disclosure may be implemented as computer programs or program code executing on programmable systems comprising at least one processor, a storage system (including volatile and non-volatile memory and/or storage elements), at least one input device, and at least one output device.

Program code, such as code 2630 illustrated in FIG. 26, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples of the disclosure also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

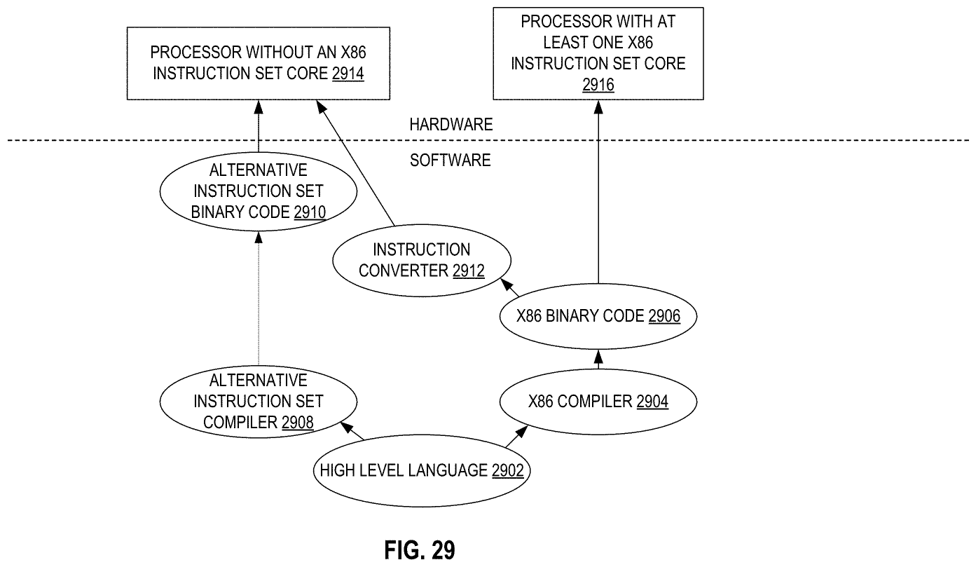

FIG. 29 is a block diagram contrasting the use of a software instruction converter to convert binary instructions in a source instruction set to binary instructions in a target instruction set according to examples of the disclosure. In the illustrated example, the instruction converter is a software instruction converter, although alternatively the instruction converter may be implemented in software, firmware, hardware, or various combinations thereof. FIG. 29 shows a program in a high-level language 2902 may be compiled using an x86 compiler 2904 to generate x86 binary code 2906 that may be natively executed by a processor with at least one x86 instruction set core 2916. The processor with at least one x86 instruction set core 2916 represents any processor that can perform substantially the same functions as an Intel® processor with at least one x86 instruction set core by compatibly executing or otherwise processing (1) a substantial portion of the instruction set of the Intel® x86 instruction set core or (2) object code versions of applications or other software targeted to run on an Intel® processor with at least one x86 instruction set core, in order to achieve substantially the same result as an Intel® processor with at least one x86 instruction set core. The x86 compiler 2904 represents a compiler that is operable to generate x86 binary code 2906 (e.g., object code) that can, with or without additional linkage processing, be executed on the processor with at least one x86 instruction set core 2916. Similarly, FIG. 29 shows the program in the high level language 2902 may be compiled using an alternative instruction set compiler 2908 to generate alternative instruction set binary code 2910 that may be natively executed by a processor without at least one x86 instruction set core 2914 (e.g., a processor with cores that execute the MIPS instruction set of MIPS Technologies of Sunnyvale, Calif. and/or that execute the ARM instruction set of ARM Holdings of Sunnyvale, Calif.). The instruction converter 2912 is used to convert the x86 binary code 2906 into code that may be natively executed by the processor without an x86 instruction set core 2914. This converted code is not likely to be the same as the alternative instruction set binary code 2910 because an instruction converter capable of this is difficult to make; however, the converted code will accomplish the general operation and be made up of instructions from the alternative instruction set. Thus, the instruction converter 2912 represents software, firmware, hardware, or a combination thereof that, through emulation, simulation, or any other process, allows a processor or other electronic device that does not have an x86 instruction set processor or core to execute the x86 binary code 2906.

What is claimed is:

1. An apparatus comprising:
a hardware processor core; and
an accelerator circuit coupled to the hardware processor core, the accelerator circuit comprising a work dispatcher circuit and one or more work execution circuits to, in response to a single descriptor sent from the hardware processor core:
when a field of the single descriptor is a first value, cause a single job to be sent by the work dispatcher circuit to a single work execution circuit of the one or more work execution circuits to perform an operation indicated in the single descriptor to generate an output, and
when the field of the single descriptor is a second different value, cause a plurality of jobs to be sent by the work dispatcher circuit to the one or more work execution circuits to perform the operation indicated in the single descriptor to generate the output as a single stream.

2. The apparatus of claim 1, wherein the single descriptor comprises a second field that when set to a first value indicates a transfer size field of the single descriptor indicates a number of bytes in an input for the operation, and when set to a second different value indicates the transfer size field of the single descriptor indicates a chunk size and a number of chunks in the input for the operation.

3. The apparatus of claim 2, wherein, when the second field is set to the second different value, the work dispatcher circuit is to cause the one or more work execution circuits to start the operation in response to receiving a first chunk of a plurality of chunks of the input.

4. The apparatus of claim 1, wherein the single descriptor comprises a second field that when set to a first value indicates a source address field or a destination address field of the single descriptor indicates a location of a single contiguous block of an input for the operation or the output, respectively, and when set to a second different value indicates the source address field or the destination address field of the single descriptor indicates a list of multiple non-contiguous locations of the input or the output, respectively.

5. The apparatus of claim 1, wherein, when the field of the single descriptor is the second different value, the work dispatcher circuit is to serialize the plurality of jobs by waiting to send a next job of the plurality of jobs to the one or more work execution circuits in response to an immediately previous job of the plurality of jobs being completed by the one or more work execution circuits.

6. The apparatus of claim 1, wherein, when the field of the single descriptor is the second different value, the work dispatcher circuit is to send the plurality of jobs in parallel to a plurality of work execution circuits.

7. The apparatus of claim 1, wherein, when the field of the single descriptor is the second different value and a metadata tagging field of the single descriptor is set, the accelerator circuit is to insert metadata into the single stream of output.

8. The apparatus of claim 1, wherein, when the field of the single descriptor is the second different value and an additional value field of the single descriptor is set, the accelerator circuit is to insert one or more additional values into the single stream of output.

9. A method comprising:
sending, by a hardware processor core of a system, a single descriptor to an accelerator circuit coupled to the hardware processor core and comprising a work dispatcher circuit and one or more work execution circuits;
in response to receiving the single descriptor, causing a single job to be sent by the work dispatcher circuit to a single work execution circuit of the one or more work execution circuits to perform an operation indicated in the single descriptor to generate an output when a field of the single descriptor is a first value; and
in response to receiving the single descriptor, causing a plurality of jobs to be sent by the work dispatcher circuit to the one or more work execution circuits to perform the operation indicated in the single descriptor to generate the output as a single stream when the field of the single descriptor is a second different value.

10. The method of claim 9, wherein the single descriptor comprises a second field that when set to a first value indicates a transfer size field of the single descriptor indicates a number of bytes in an input for the operation, and when set to a second different value indicates the transfer size field of the single descriptor indicates a chunk size and a number of chunks in the input for the operation.

11. The method of claim 10, wherein, when the second field is set to the second different value, the work dispatcher circuit causes the one or more work execution circuits to start the operation in response to receiving a first chunk of a plurality of chunks of the input.

12. The method of claim 9, wherein the single descriptor comprises a second field that when set to a first value indicates a source address field or a destination address field of the single descriptor indicates a location of a single contiguous block of an input for the operation or the output, respectively, and when set to a second different value indicates the source address field or the destination address field of the single descriptor indicates a list of multiple non-contiguous locations of the input or the output, respectively.

13. The method of claim 9, wherein, when the field of the single descriptor is the second different value, the work dispatcher circuit serializes the plurality of jobs by waiting to send a next job of the plurality of jobs to the one or more work execution circuits in response to an immediately previous job of the plurality of jobs being completed by the one or more work execution circuits.

14. The method of claim 9, wherein, when the field of the single descriptor is the second different value, the work dispatcher circuit sends the plurality of jobs in parallel to a plurality of work execution circuits.

15. The method of claim 9, wherein, when the field of the single descriptor is the second different value and a metadata tagging field of the single descriptor is set, the accelerator circuit inserts metadata into the single stream of output.

16. The method of claim 9, wherein, when the field of the single descriptor is the second different value and an additional value field of the single descriptor is set, the accelerator circuit inserts one or more additional values into the single stream of output.

17. An apparatus comprising:
a hardware processor core comprising:
a decoder circuit to decode an instruction comprising an opcode into a decoded instruction, the opcode to indicate an execution circuit is to generate a single descriptor and cause the single descriptor to be sent to an accelerator circuit coupled to the hardware processor core, and
the execution circuit to execute the decoded instruction according to the opcode; and
the accelerator circuit comprising a work dispatcher circuit and one or more work execution circuits to, in response to the single descriptor sent from the hardware processor core:
when a field of the single descriptor is a first value, cause a single job to be sent by the work dispatcher circuit to a single work execution circuit of the one or more work execution circuits to perform an operation indicated in the single descriptor to generate an output, and
when the field of the single descriptor is a second different value, cause a plurality of jobs to be sent by the work dispatcher circuit to the one or more work execution circuits to perform the operation indicated in the single descriptor to generate the output as a single stream.

18. The apparatus of claim 17, wherein the single descriptor comprises a second field that when set to a first value indicates a transfer size field of the single descriptor indicates a number of bytes in an input for the operation, and when set to a second different value indicates the transfer size field of the single descriptor indicates a chunk size and a number of chunks in the input for the operation.

19. The apparatus of claim 18, wherein, when the second field is set to the second different value, the work dispatcher circuit is to cause the one or more work execution circuits to start the operation in response to receiving a first chunk of a plurality of chunks of the input.

20. The apparatus of claim 17, wherein the single descriptor comprises a second field that when set to a first value indicates a source address field or a destination address field of the single descriptor indicates a location of a single contiguous block of an input for the operation or the output, respectively, and when set to a second different value indicates the source address field or the destination address field of the single descriptor indicates a list of multiple non-contiguous locations of the input or the output, respectively.

21. The apparatus of claim 17, wherein, when the field of the single descriptor is the second different value, the work dispatcher circuit is to serialize the plurality of jobs by waiting to send a next job of the plurality of jobs to the one or more work execution circuits in response to an immediately previous job of the plurality of jobs being completed by the one or more work execution circuits.

22. The apparatus of claim 17, wherein, when the field of the single descriptor is the second different value, the work dispatcher circuit is to send the plurality of jobs in parallel to a plurality of work execution circuits.

23. The apparatus of claim 17, wherein, when the field of the single descriptor is the second different value and a metadata tagging field of the single descriptor is set, the accelerator circuit is to insert metadata into the single stream of output.

24. The apparatus of claim 17, wherein, when the field of the single descriptor is the second different value and an additional value field of the single descriptor is set, the accelerator circuit is to insert one or more additional values into the single stream of output.
